(19) United States
(12) Patent Application Publication
(10) Pub. No.: US 2024/0254029 A1
(43) Pub. Date: Aug. 1, 2024

(54) METHOD OF CONTROL, CONTROL SYSTEM AND GLASS FURNACE, IN PARTICULAR FOR TEMPERATURE/THERMAL CONTROL

(71) Applicant: GLASS SERVICE, A.S., Vsetin (CZ)

(72) Inventors: Pavel VIKTORIN, Vsetin (CZ); Matej PARADZIK, Metkovic (HR); Robert BÔDI, Vsetin (CZ); Jan BENSCH, Halenkov (CZ); Josef CHMELAR, Vsetin (CZ)

(21) Appl. No.: 18/562,460

(22) PCT Filed: May 19, 2021
(86) PCT No.: PCT/EP2021/063264

§ 371 Date: Nov. 20, 2023

(51) Int. Cl. C03B 5/24; G06T 7/00; G06T 7/73

(52) U.S. Cl. CPC C03B 5/24; G06T 7/0004; G06T 7/73; G06T 2207/20084

(57) ABSTRACT

The invention relates to a method of monitor and/or control of operation of an in-dustrial furnace for processing a heated material, in particular for processing a melt in a melting end of a kiln or the like industrial furnace, wherein the industrial furnace has an inner furnace space comprising a furnace crown, a furnace superstructure and a furnace material basin, wherein in the method: —an image process of at least a part of the furnace space is provided. namely provided with a series of images in the course of time, —wherein an image of the series is provided by means of a camera sensor of a camera. the camera being installed at the furnace with a camera view to the furnace space, —and the image of the furnace space is related to a technical map of at least one process parameter of the furnace space during operation of the furnace by means of an image point read out, and—wherein a process parameter (P) is used in the monitor and/or control of operation, and—an image point (i, j) of the image, in particular pixel image A(i, j), corresponds to an object-image position assigned to an object location (x, y, z) of an object in the furnace space B(x, y, z), wherein the image point is related with a sensor point of the camera sensor.

The invention relates to a method of monitor and/or control of operation of an industrial furnace for processing a heated material according to the preamble part of claim 1. The invention also relates to a control system for an industrial furnace.

Glass or other material melting and similar or other high temperature processes inside an industrial furnace and the like industrial kilns involve a high temperature treatment of the glass and other materials resulting in large energy consumption. Other materials, as an example, can relate to non-ferrous metals, cement and ceramics. The high temperatures of the treatment are typically within 800° C.-1700° C. As a consequence thermal and corrosive destruction of the furnace ceramic structures and related defects coming from the furnace lining materials are immanent. Moreover, the high temperature processes require precise control to achieve proper thermal treatment of the raw materials and their conversion to the product of the desired parameters and quality.

In order to control these high temperature processes industrial furnaces and kilns are controlled using data of process parameters measured by conventional sensors such as thermocouples, pyrometers, flow meters, etc. The control strategy aims at set point values of the readings from such a conventional sensor. Typically a desired set point value is achieved by changes of the quantity of the fuel (like fuel gas as e.g. hydrocarbons or hydrogen) and oxidizer (like e.g. air or oxygen), changes of the electric energy input parameters and batch material charging rate manipulation. Additionally, parameters such as furnace pressure, molten material level, excess oxygen in the flue gases are monitored and controlled.

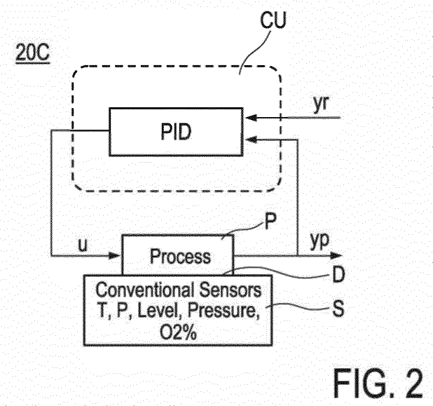

The control can be conducted manually or automatically through a control method such as a PID-control (known as Proportional/Integral/Derivative-Controller); a contemporary example of embodiment is described with FIG. 2. A control for a glass industrial furnace is of particular interest.

Above mentioned solutions and latest trends in the industrial practice further suggest to use visual and thermal and/or imaging cameras in the VIS, NIR, UV and the like electro-magnetic radiation spectrum for measurement to support control operation of the industrial kilns, glass furnaces and the like industrial furnaces. A conceptual approach has recently been disclosed in WO 2018/104695 A1; therein the use of the thermal imaging in a glass furnace control is described in general terms on a system basis.

The advantages of a visual representation of temperature fields, generally, are explained as being early and comprehensive. However, also a problem seems to arise as the structural elements for providing the VIS, NIR, UV and the like electromagnetic radiation or the like camera based representation undergo a drift. For instance, due to distress and strain during thermal expansion of the furnace structure, drift of a camera mechanical fixation, drift of a camera optical system and setting's changes or drifts of the like.

Whereas in general calibration techniques as such are known for industrial infrastructure from US 2019/0179271 A1, such methods have still been under-estimated to features which are due in visual thermal control of glass furnaces.

On the other hand, sophisticated analysis and control has been proposed as for instance in US 2002/0124598 A1 or concept aspects have been addressed in WO 2018/104695 A1. US 2002/0124598 A1 shows a method where a camera system is used in connection with Neural Networks or Fuzzy Logic for temperature and batch length control.

Another approach is described in US 2004/0079113 A1; it discloses a controller based on batch coverage, batch compression, the position of the thermal key points of the heat sinks and sources, which are optically measured and subsequently controlled by the energy input. The base of this approach lays in the optically measured proportion of the batch coverage on the glass bath surface controlled by the energy input.

Still, the main underlying systematic problem of such sophisticated methods has yet not been fully addressed to features which are due in visual and/or thermal control of glass furnaces.

In EP 3 265 431 A1 a method to improve thermal symmetry of the end port furnace is explained.

Contemporary control systems for glass furnaces thus aim for a thermal control based on a visual and/or thermal representation of a temperature field within the furnace room of an industrial furnace, in particular a temperature field within the processing of a glass melt in a melting end of a kiln or the like glass furnace room of a glass industrial furnace.

Such or the like method of operation of an industrial furnace for processing a heated material, in particular for processing a melt in a melting end of a kiln or the like industrial furnace, are directed to an industrial furnace having an inner furnace space. The inner furnace space in particular comprises a furnace crown, a furnace superstructure and a furnace material basin, in particular for control of a high temperature process. The furnace superstructure among others comprises a batch opening or other kind, forms and devices for material supply and a heating device or the like for heating the material. In particular, in this and other embodiments the heating device is formed as burner arrangement with a group of burners and burner ports, oxidiser inlet and combustion products outlet. Also, other r forms of heating devices can be provided. Further, the furnace structure preferably provides a bubbling system, which is known in the art to be adapted for creating a controlled disturbance in the glass melt; air or other gases are blown through special bubbler nozzles into the furnace.

In a contemporary method:
an image process of at least a part of the furnace space is provided, namely provided with a series of images in the course of time,
wherein an image of the series is provided by means of a camera sensor of a camera, the camera being installed at the furnace with a camera position and/or directed to the furnace space with a camera view (CAM_V) to the furnace space, in particular a camera orientation wherein a camera pose is assigned to the position and/or orientation of the camera,
and the image of the furnace space is related to a technical map of at least one process parameter of the furnace space during operation of the furnace by means of an image point read out, and
wherein a process parameter is used in the monitor and/or control of operation.

Usually therein, an image point of the image, in particular pixel image, corresponds to an object-image position assigned to an object location of an object in the furnace space.

One of such methods, as mentioned in the introduction, is known from EP 1 655 570 A1, which claims to provide a geometric reference of the furnace as condition for such visual representation, which is based on a first geometric position and a geometric reference position in said visual presentation.

A coordinate system is a basis and is chosen as fixed wherein thermal coefficients of the materials involved are used to compensate for thermally caused deviations in a correction to the geometry of the furnace when being imaged. Thereby a more precise temperature measurement of the furnace walls and identification of the molten material by the camera system is possible in reference to the coordinate system of the furnace imaged.

Such approach at least recognized the importance of a precise coordinate system as a condition to provide a precise temperature measurement; however, still such approach can be significantly improved.

This is where the invention comes in, the object is to provide a method of monitor and/or control of operation of an industrial furnace and the object is to provide a control system, which are improved to provide an improved measurement as compared to contemporary systems of image based measurement; in particular a more precise temperature or other process parameters measurement as compared to contemporary systems of image based measurement should be provided. The object is also to provide an improved industrial furnace in this regard.

In particular, therein a camera-based collection of electromagnetic radiation—preferably including use of a thermal imaging camera for temperature control of a glass furnace should aim to provide a three-dimensional furnace imaging based on the camera taken.

Preferably, it is an object to calibrate or correct the setting of said camera and/or to calibrate or correct the output of said camera to provide improved visual to 3D-pictoral information.

The calibration and/or operation of the camera shall be based to provide improved monitor and correction of the camera situation, which has been understood to be the main systematic error impact on a highly sophisticated visual-based temperature control of the glass furnace.

In particular, it is a further object to provide an improved concept of monitor and/or control of operation of an industrial furnace, in particular for temperature/thermal control. This can also imply or embrace improved solutions to monitor and/or control of the oxidizer and/or fuel supply system, the flame building and flame stabilization or batch position measurement. Preferably this is free of demands for a fixed coordinate system of furnace and/or fixed camera pose (position and orientation).

The solution to the problem as to a first aspect regards the position, in particular pose, of the camera. The object is solved with a subject matter as claimed by the features of claim 1.

The invention also leads to a control system adapted to execute the method as claimed in claim 17.

With regard to the method the invention starts from a method of monitor and/or control of operation of an industrial furnace for processing a heated material.

This in particular applies for processing a melt in a melting end of a kiln or the like industrial furnace, wherein the industrial furnace has an inner furnace space. The inner furnace space preferably comprises a furnace crown, a furnace superstructure and a furnace material basin. Therein in the method:
an image process of at least a part of the furnace space is provided, namely provided with a series of images in the course of time,
wherein an image of the series is provided by means of a camera sensor of a camera, the camera being installed at the furnace with a camera view to the furnace space,
and the image of the furnace space is related to a technical map of at least one process parameter of the furnace space during operation of the furnace by means of an image point read out, and
wherein a process parameter (P) is used in the monitor and/or control of operation.

Further the invention provides that
an image point of the image, in particular pixel image, corresponds to an object-image position assigned to an object location of an object in the furnace space, wherein the image point is related with a sensor point of the camera sensor.

Further, it has been considered as particular improvement to provide according to the invention, that:
a reference image of the furnace space is provided at an initial time during the course of time,
an actual image is provided at a further time during the course of time,
a characteristic object-image position is identified in the actual image and a corresponding characteristic object-image position is identified in the reference image,
a deviation is identified for the characteristic object-image position in the actual image as compared to the characteristic object-image position in the reference image,
a deviation-compensation is provided to the object-image position in the actual image, in particular to apply for a varying camera view, wherein the deviation-compensation is based on the deviation identified, and
a process parameter is determined by means of the deviation-compensated object image position in the actual image.

The invention in particular has recognized that the camera view is subject to a camera view variation in the course of time, in particular due to ambient conditions of the furnace. The ambient conditions of the furnace can change such that the camera view variation causes a deviation of the image point from the object-image position. In particular therein with varying camera pose in the course of time the image point deviates from the corresponding object-image position. The invention can be applied with a single camera or a number of cameras; as an example not only one but also additionally one or more cameras can be used as will be clear also from the description of the drawing.

The invention even more particular has realized that the image is provided with a number of image points, in particular as a pixel image. Therein an image point is assigned to a sensor point, in particular sensor pixel, of the camera sensor. Thus, in particular therein the image point is related with a sensor point of the camera sensor. In case of a pixel sensor the picture is a pixel image.

In short terms the invention recognized to provide an improved method in that—unlike sophisticated modelling of the changes to the setting of camera and furnace—a varying camera view, in particular camera pose, in the course of time can be applied for by image analysis as such. Thus the approach is to provide a deviation-compensation to the object-image position in the actual image to apply for the varying camera pose is considered as particular useful.

Specifically it is an achievement of the invention to provide an adequate correction to the imaging of the camera or the like imaging means, which applies for the varying camera pose in the course of time; namely wherein the deviation-compensation is based on a deviation identified for a characteristic object-image position in the actual image as compared to the reference image. Preferably, in a development it is achieved to correct that the image point deviates from the corresponding object-image position.

Thereby, in particular it is an achievement that the image of the furnace space is related to a technical map of at least one process parameter of the furnace space during operation of the furnace by means of an image point read out which image point read out applies for the fact that the image point deviates from the corresponding object-image position. Thus, a deviation-compensation is provided to the object-image position in the actual image, in particular to apply for a varying camera view, wherein the deviation-compensation is based on the deviation identified, and
a process parameter is determined by means of the deviation-compensated object image position in the actual image.

Thereby, a thermal control of the furnace relies on true temperature deviations rather than changes, which (false positive) merely seem to be temperature deviations, but indeed are resided in the fact that the camera positon changes and pixels of the thermal image are assigned to one position (this means one and the same position), which, however, are not.

One aspect thereof is resided in a sufficient monitor and adaptation of varying camera position and pose; this is, pose and orientation of the camera within the three-dimensional coordinate system of the glass furnace Therein said three-dimensional coordinate system is also the three-dimensional coordinate system to be based for the three-dimensional temperature representation within the glass furnace.

In development, it is proposed, that object or fixed identification can be used to identify an updated camera position with deviations over time. Whereas this improved calibration or correction is ongoing for different points of time, it is known, that the objects relied on for calibration do not change in position. Thus, the camera position, which may vary, is calibrated in relation to fixed objects in the furnace.

This being said, the invention has recognized that due to the dimensional extensive distances in the glass furnace to be captured with thermal imaging, even the smallest position or functional variation can be detrimental, not necessarily to the picture quality, but may severely affect the relation between the geometric placement of the three-dimensional thermal field (assignment to the three-dimensional temperature field to the three-dimensional coordinate system of the furnace and camera) and to the temperature measured thereby.

The invention also leads to an improved control system of claim 17 adapted to execute the method of the invention.

The inventive control system preferably provides for a camera adapted in that
an image process of at least a part of the furnace space is provided, namely provided with a series of images in the course of time,
wherein an image of the series is provided by means of a camera sensor of a camera, the camera being installed at the furnace with a camera view to the furnace space, and
   a read out module is adapted in that
the image of the furnace space is related to a technical map of at least one process parameter of the furnace space during operation of the furnace by means of an image point read out, and
wherein a process parameter is used in the monitor and/or control of operation, and
an image point of the image, in particular pixel image, corresponds to an object-image position assigned to an object location of an object in the furnace space, wherein the image point is related with a sensor point of the camera sensor.

The inventive control system preferably further provides for a read out module adapted in that
the image of the furnace space is related to a technical map of at least one process parameter of the furnace space during operation of the furnace by means of an image point read out, and
wherein a process parameter is used in the monitor and/or control of operation, and
an image point of the image, in particular pixel image, corresponds to an object-image position assigned to an object location of an object in the furnace space, wherein the image point is related with a sensor point of the camera sensor.

The inventive control system preferably further provides for an image taking module adapted in that
a reference image of the furnace space is provided at an initial time during the course of time,
an actual image is provided at a further time during the course of time.

The inventive control system preferably further provides for a deviation-compensation module adapted in that
a characteristic object-image position is identified in the actual image and a corresponding characteristic object-image position is identified in the reference image,
a deviation is identified for the characteristic object-image position in the actual image as compared to the characteristic object-image position in the reference image,

The control unit is further adapted in that
a process parameter is determined by means of the deviation-compensated object image position in the actual image.

Preferably, the image of the furnace space which is used for relating into the imaging technical map of process parameters is determined by means of the deviation-compensated object image position in actual image.

Also in the control the invention takes advantage from recognizing that it can be assumed that with varying camera view, in particular camera pose, in the course of time the image point deviates from the corresponding object-image position.

Preferably, the process parameter is used to monitor the industrial furnace operation and/or to control the industrial furnace operation in a feed-forward loop or a feed-back control loop of control.

Preferably, enhanced control parameters are based on corrected camera imaging results.

Preferably images obstructed by the deposits and/or blurred images and/or barrel and pincushion distortion or the like optical system distortions are compensated.

The invention also leads to an improved industrial furnace for processing a heated material, in particular for processing a melt in a melting end of a kiln or the like industrial furnace, wherein the industrial furnace has an inner furnace space comprising a furnace crown, a furnace superstructure and a furnace material basin and comprising a control system adapted to execute the method of the invention.

The improved industrial furnace of the invention in particular comprises the inventive control system. Preferably, an industrial furnace for processing a heated material is provided, in particular for processing a melt in a melting end of a kiln or the like industrial furnace, as shown herewith, wherein the industrial furnace has an inner furnace space. The inner furnace space preferably comprises a furnace crown, a furnace superstructure and a furnace material basin and comprising a control system as described hereinbefore and/or adapted to execute the method as described hereinbefore.

The furnace superstructure among others preferably comprises a batch opening or other kind, forms and devices for material supply and a heating device or the like for heating the material. In particular in this and other embodiments the heating device is formed as burner arrangement with a group of burners and burner ports, oxidiser inlet and combustion products outlet. Also other kind or forms of heating devices can be provided. Further, the furnace structure preferably provides a bubbling system, which is known in the art to be adapted for creating a controlled disturbance in the glass melt; air or other gases are blown through special bubbler nozzles into the furnace.

The industrial furnace can be formed as a glass furnace with a furnace space comprising a furnace crown and a superstructure over a material basin with a glass melt, and/or with the control applying to control of a high temperature process.

A monitor and/or control of furnace can include separately or in combination include one or more of supporting operations selected from the tasks of operating, monitoring or controlling: a flame of the heating device, a batch flow through a batch opening, a batch flow on the melt, a heated material flow and/or bubbling.

Further developments of the subject matter of the invention as claimed can be derived from the dependent claims which improve the invention with further features and aspects, which are described in the description below with further advantages and details related therewith.

Preferably a deviation-compensation is provided to the object-image position in the actual image, wherein the deviation-compensation is based on the deviation identified, and
the image of the furnace space which is used for relating into the imaging technical map of process parameters, wherein the process parameters are determined by means of a deviation-compensated object-image position.

Preferably the camera view is subject to a camera view variation in the course of time, in particular due to ambient conditions of the furnace, such that the camera view variation causes a deviation of the image point from the object-image position.

Preferably the camera has a camera position and/or being directed to the furnace space with a camera orientation, wherein a camera pose is assigned to the position and/or orientation of the camera, and/or
with varying camera pose in the course of time the image point (i, j) deviates from the corresponding object-image position.

Preferably the image is provided with a number of image points, in particular as a pixel image, wherein an image point is assigned to a sensor point, in particular sensor pixel, of the camera sensor.

A particular improved development provides the deviation identified for a characteristic object-image position in the actual image as compared to the actual image. In particular therein
the reference image of the furnace space is provided at the initial time, and a characteristic object in the furnace space is selected at the initial time, wherein the characteristic object-image position corresponds to an original image point in the reference image, and
the actual image is provided at the further time, wherein the original image point, being related with the sensor point of the camera sensor in the actual image, corresponds to another object-image position of another object.

Additionally or alternatively it is preferred that
the characteristic object-image position is identified to correspond to another image point being related with the sensor point of the camera sensor in the actual image.

Preferably
the deviation-compensation is provided to the object-image position in the actual image and applies for the varying camera pose, in that
the deviation-compensation is determined by means of identifying a deviation between the original image point and the another image point in the actual image.

It has been shown as particular improved development in this regard that a characteristic object-image position corresponds to an original image point in the reference image in that an image point of the image, in particular pixel image, corresponds to the characteristic object-image position and/or
an object-image position is assigned to a characteristic object, in particular fixed object, wherein the characteristic object corresponds to one or more selected points of a group or cluster of points of interest, in particular in the reference image.

In particular at least one point of interest in the reference image is selected, such that the point of interest is assigned to the characteristic object and the object-image position of the point of interest is determined as an image point of the image, in particular pixel image.

In particular therein the characteristic object-image position is identified to correspond to another image point in the actual image, in particular pixel image, wherein at least some of the selected points of interest are also identified in the actual image.

More preferably the deviation between the original image point and the another image point in the actual image results from a deviation-relation between at least some of the selected points of interest and is used to determine the deviation-compensation to the object-image position in the actual image.

Further developments of the subject matter of the invention as claimed is considered in the follow up developments.

It has been considered as particular preferable that
the varying camera pose in the course of time is a drift of camera pose, and/or
the image point assigned to a sensor pixel of the camera sensor deviates from the corresponding object-image position and results into a difference between an image point read out at the initial time and an image point read out at the further point of time.

It has been considered as particular preferable that
the furnace is a glass furnace with a furnace space comprising a furnace crown and a superstructure over a material basin with a glass melt, and/or
the control applies to control of a high temperature process.

It has been considered as particular preferable that the process parameter is used to monitor the industrial furnace operation and/or to control the industrial furnace operation in a feed-forward loop or a feed-back control loop of control.

It has been considered as particular preferable that
the object-image position is assigned to an object location by an assignment which is evaluated by means of a transformation function, and/or
a deviation-compensating transformation function is applied to the actual image.

It has been considered as particular preferable that
the deviation-relation between said at least some of the selected points of interest, namely as identified in the reference image and in the actual image, is used to determine the deviation-compensating transformation function to the object-image position in the actual image.

It has been considered as particular preferable that
a deviation-compensation to the object-image position in the actual image is applied, such that the image point of the pixel image of the deviation-compensated transformed object-image position in the actual image is assigned to the original location of the object.

It has been considered as particular preferable that the assignment is evaluated by means of an inverse transformation function.

It has been considered as particular preferable that
points of interest are identified in the reference image by means of a graphical image analysis wherein:
processed material, in particular melt, and/or an interface between melt and furnace structure is identified enabling discriminating between the furnace crown and a superstructure and a material basin
processed material is excluded from selecting the points of interest.

It has been considered as particular preferable that
means of graphical image analysis for discriminating between furnace crown and furnace material basin and selection of points of interest are selected from the group of means comprising:
graphical image analysis means for identifying high values or extrema of pixel amplitude and/or pixel-to-pixel gradient
graphical image analysis means for identifying confined or line or sharp image structures, in particular edge or point like structures
graphical image analysis means for identifying fixed objects as stand-still or essentially static,
neural network graphical image analysis means for learning of discriminating between furnace crown and superstructure, furnace material basin and other objects.

It has been considered as particular preferable, in particular in the control, that enhanced control parameters are based on corrected camera imaging results.

It has been considered as particular preferable, in particular in the control, that images obstructed by the deposits and/or blurred images and/or barrel and pin-cushion distortion or the like optical system distortions are compensated.

In a second aspect, in particular in the control, during operation, the situation of a camera is monitored with regard to signal quality knowing that the signal quality has severe impact on the temperatures assigned thereto during calibration.

The invention proposes in a second aspect that image analysis is also used to identify camera fogging and any deposits obstructing the camera view. Also here, the image analysis employs for example but not limited to manual labelling, segmentation and reference objects, which are fixed and secured in the sense of radiation taken by the camera.

Thus, the invention has recognized for the first time a problem of monitor and adaptation of camera situation is resided in knowing about detrimental effect to the camera as to its ability to provide pictures of sufficient quality for temperature control.

Disturbance or adverse effects to the camera objectives are sneaking, and like sneaking deviations from original positions, these aspects of geometric and functional deviations to the camera, however, as small as they may be, have been found to be severely detrimental to the ability to provide thermal control to the glass furnace.

These and other aspects of the invention will be apparent from and elucidated with reference to the embodiments described hereinafter. The embodiments of the invention are described in the following on the basis of the drawings in comparison with the state of the art, which is also partly illustrated. The latter is not necessarily intended to represent the embodiments to scale. Drawings are, where useful for explanation, shown in schematized and/or slightly distorted form. With regard to additions to the lessons immediately recognizable from the drawings, reference is made to the relevant state of the art. It should be borne in mind that numerous modifications and changes can be made to the form and detail of an embodiment without deviating from the general idea of the invention. The features of the invention disclosed in the description, in the drawings and in the claims may be essential for the further development of the invention, either individually or in any combination.

In addition, all combinations of at least two of the features disclosed in the description, drawings and/or claims fall within the scope of the invention. The general idea of the invention is not limited to the exact form or detail of the preferred embodiment shown and described below or to an object, which would be limited in comparison to the object claimed in the claims. For specified design ranges, values within the specified limits are also disclosed as limit values and thus arbitrarily applicable and claimable.

Further advantages, features and details of the invention result from the following description of the preferred embodiments as well as from the drawings, which show in:

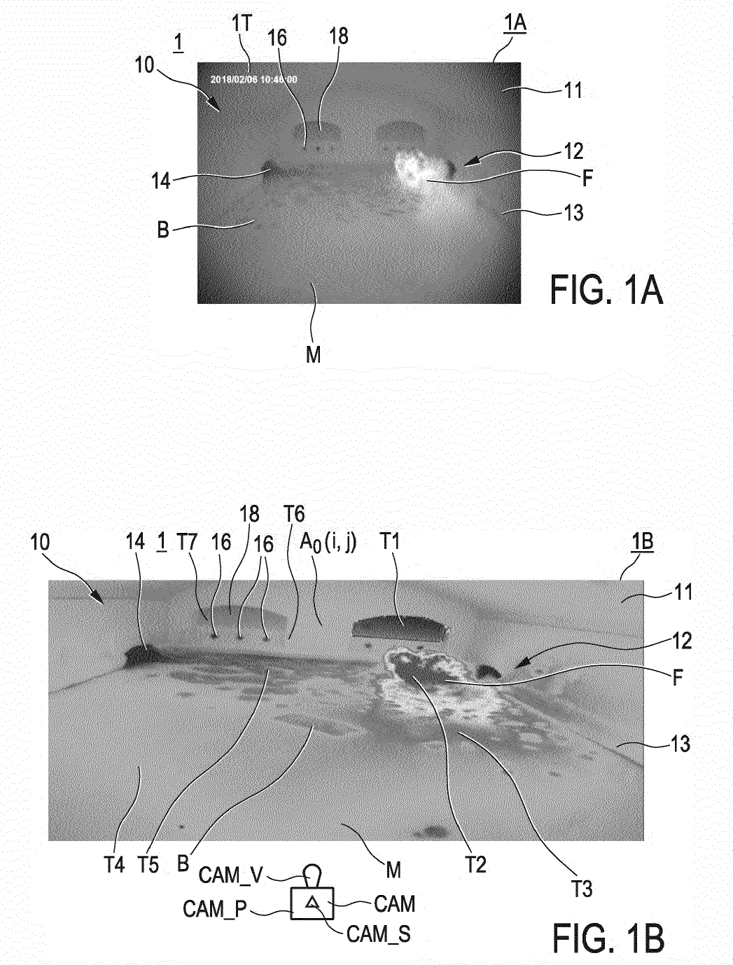

FIG. 1A a furnace image captured by the furnace camera;

FIG. 1B a thermal image showing group of selected points around the burner port;

FIG. 2 a process control using conventional sensors and PID control strategy;

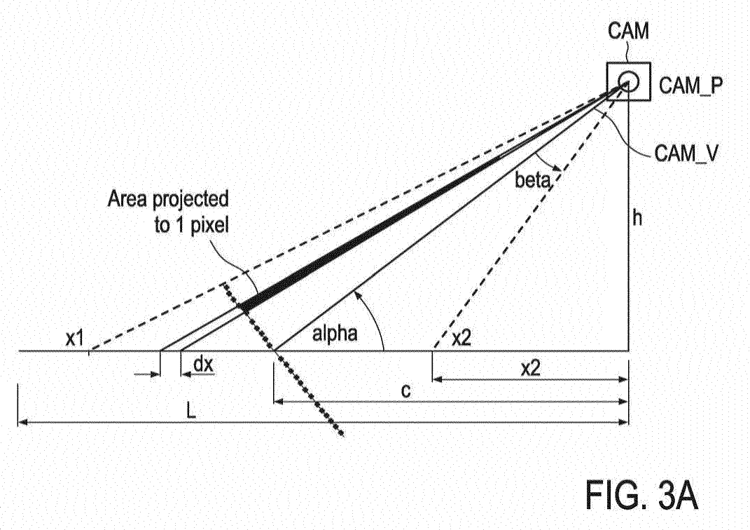

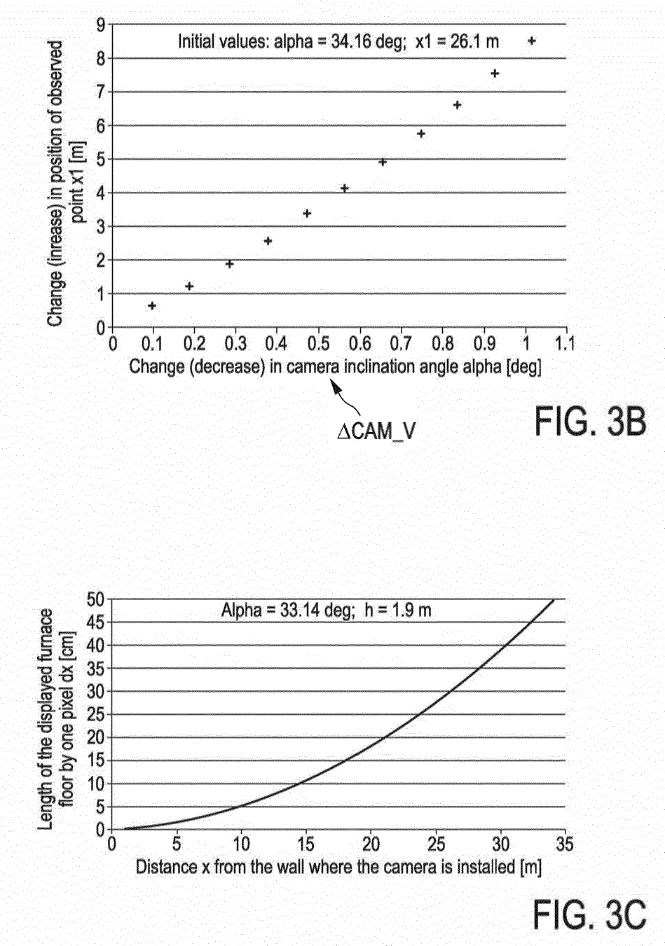

FIG. 3A a schematic geometrical representation of the furnace and camera position;

FIG. 3B a variation of a given observed point position with camera inclination angle;

FIG. 3C a relation between the lengths of the displayed furnace floor by one pixel of the camera sensor as a function of the distance of this point from the camera; a vertical pixel resolution is 1080 pixels per viewed area;

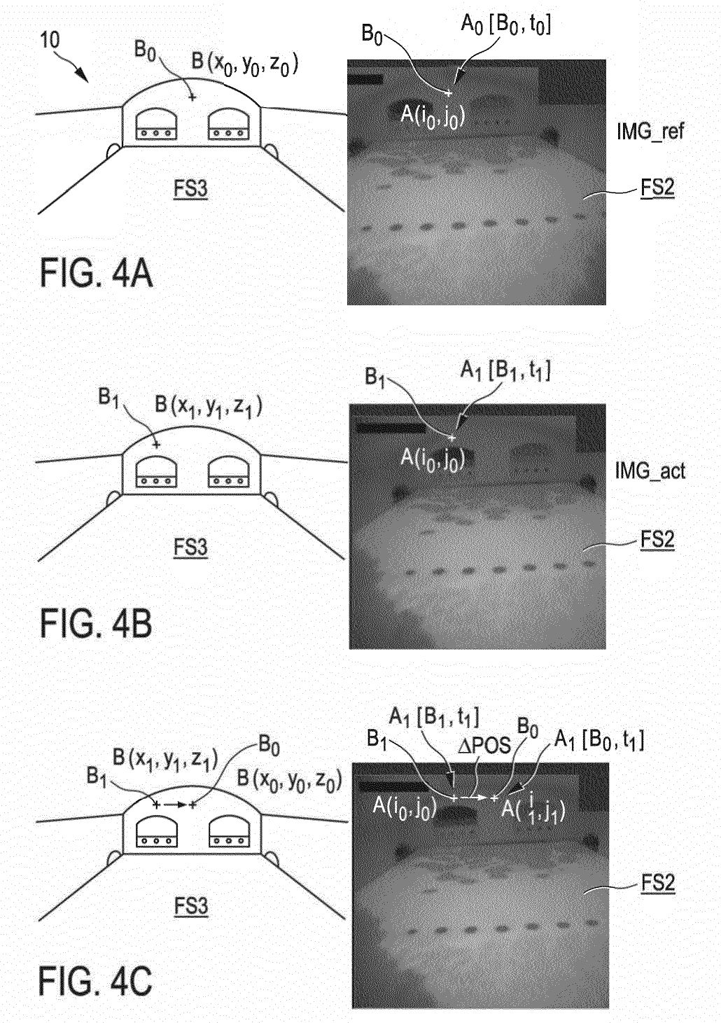

FIG. 4A a schema of the 3D-furnace space (on the left) and the corresponding 2D-image (on the right) taken by a camera at initial pose;

FIG. 4B a schema of the 3D-furnace space (on the left) and the corresponding 2D-image (on the right) taken by the camera after a change of its pose;

FIG. 4C a schema of the 3D-furnace space (on the left) and the corresponding 2D-image (on the right) showing correction performed by the deviation-compensation using the inverse transformation function T⁻¹;

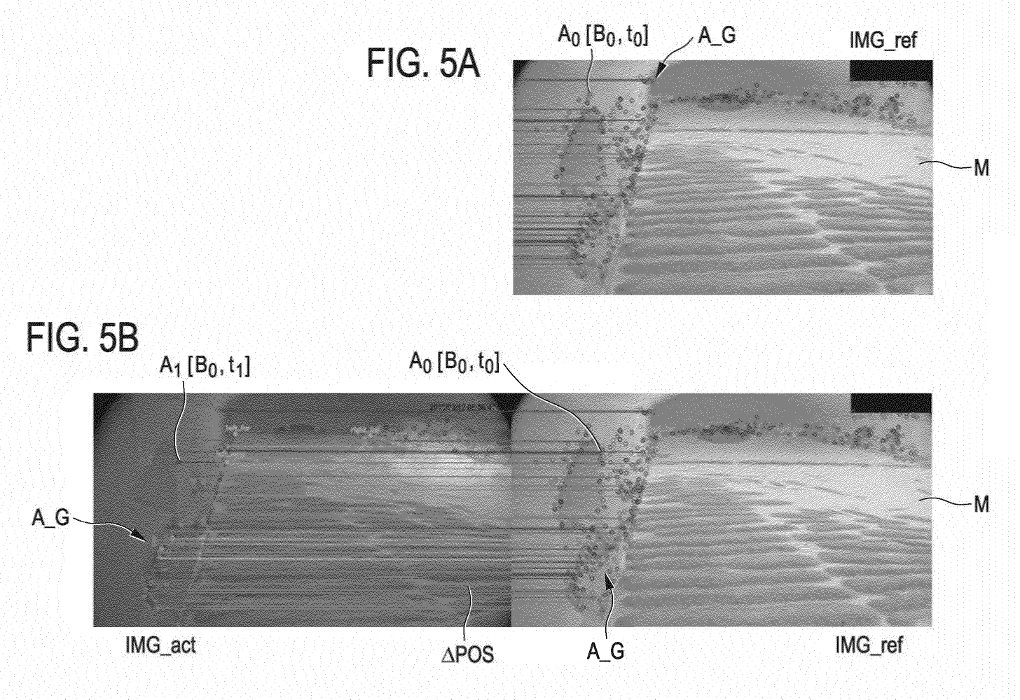

FIG. 5A a reference image with example of identified points of interest and a glass melt surface;

FIG. 5B a comparison of reference image (on the right) with the actual image (on the left) as a basis for transformation function T determination;

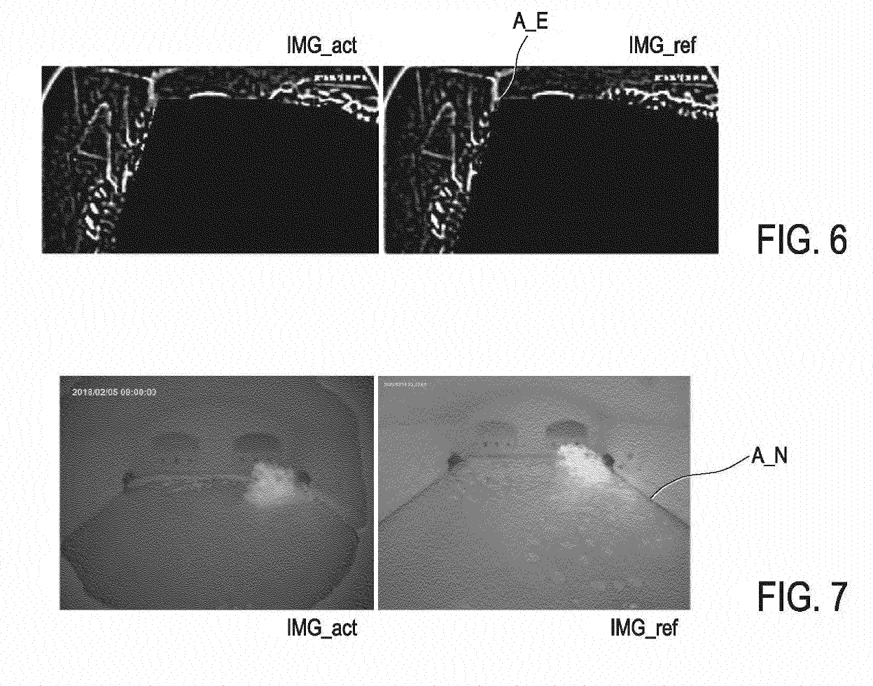

FIG. 6 the edges of visible objects inside the furnace identified by image analysis; therein two consequent images (reference image on the right and the actual image on the left) serving as a basis for transformation function T determination;

FIG. 7 fixed objects (coloured in red—furnace superstructure, coloured in blue—melt level, coloured in grey—observation hole edges) inside the furnace identified by means of neural network as a basis for determination of the transformation function T;

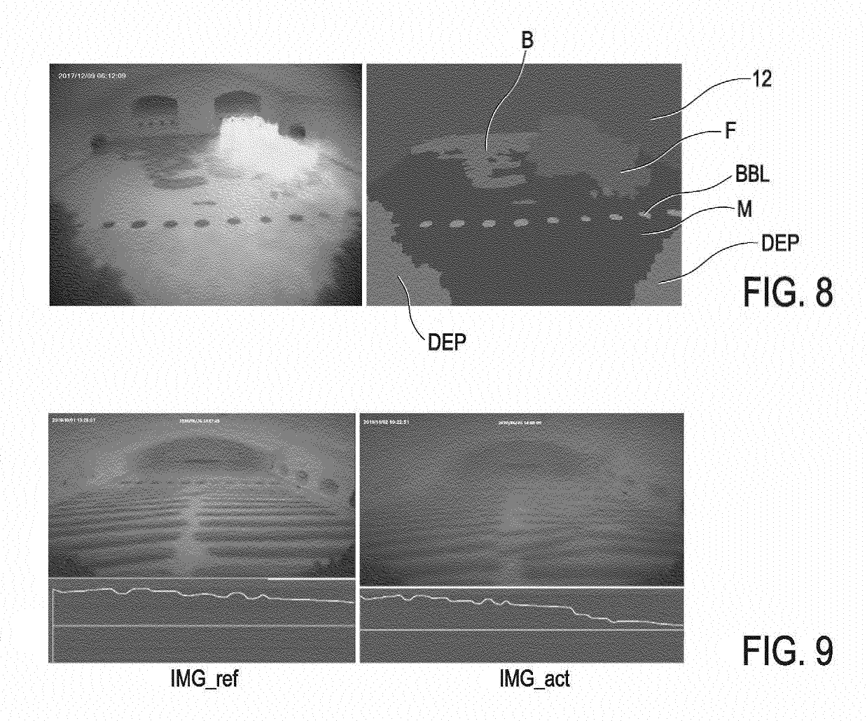

FIG. 8 an original image (left) obstructed by deposits (see dark corner areas at the bottom of the image) and a neural network analysis of the image (right side); it reveals to show identified deposits (grey color), and clearly distinguishes these from the batch (ochre), flame (purple), bubbler (pink), glass melt (violet), and a superstructure (green) of the furnace;

FIG. 9 a reference not blurred image (left) and the actual blurred image (right);

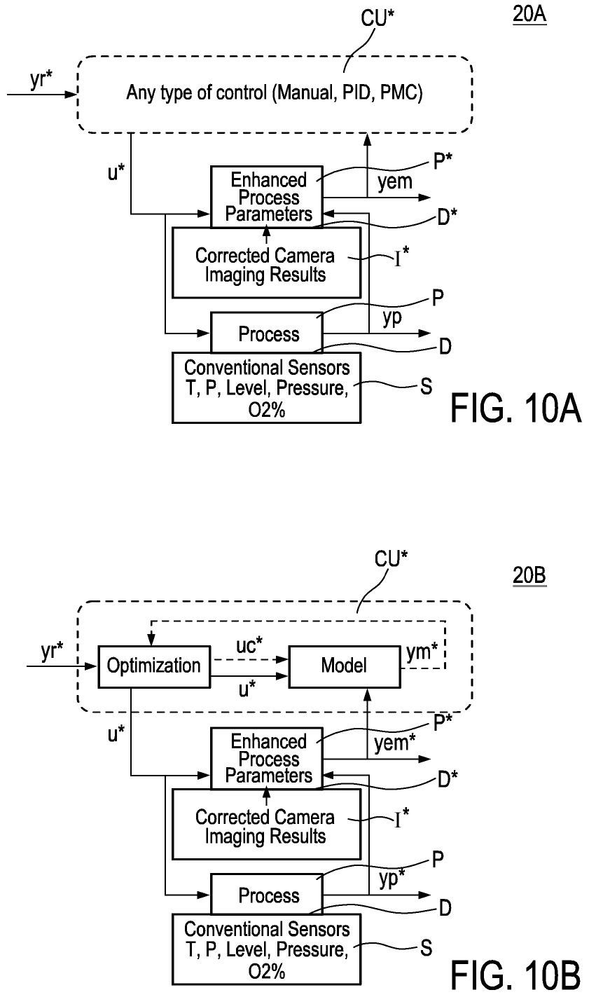

FIG. 10A a new control approach using enhanced control parameters based on corrected camera imaging results;

FIG. 10B a control scheme using model based predictive control and enhanced control parameters based on corrected camera imaging results;

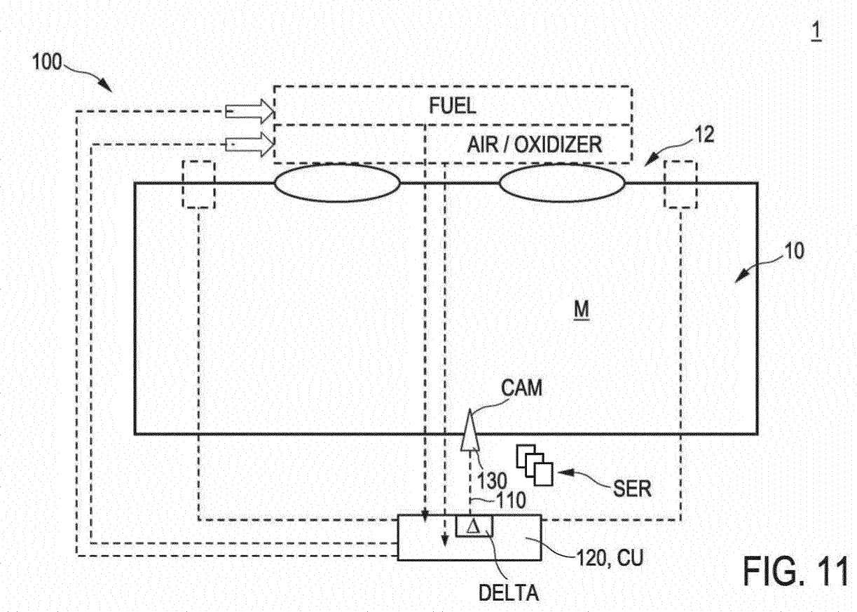

FIG. 11 a scheme of furnace and an embodiment of control for the furnace to implement the concept of the invention;

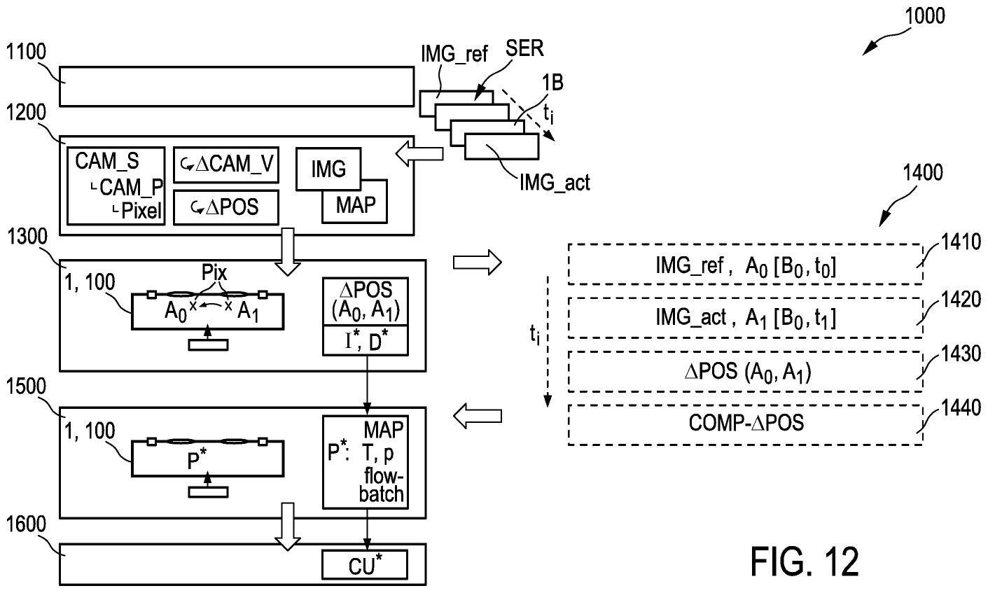

FIG. 12 a flow chart of a method according to a preferred embodiment.

Latest solutions and trends in the industrial practice suggest to use visual and thermal imaging cameras or the like imaging means for measurement of the industrial kilns and glass furnaces.

FIG. 1A shows a visible furnace image 1A of a furnace 1 captured by the furnace camera. The visible furnace image 1A of FIG. 1A in the visible range immediately reveals the structural properties of the furnace 1. The structural properties of the furnace 1 are adapted for processing a melt M in a melting end of a kiln or the like industrial furnace. Among others, the industrial furnace 1 is established with the inner furnace space 10 comprising a furnace crown 11, a furnace superstructure 12 and a furnace material basin 13, with the melt M and batch material B and flame F for heating as visible in furnace image 1A.

Corresponding features are also shown in the thermal furnace image 1B of FIG. 1B. FIG. 1B depicts an exemplary outcome of an exemplifying present camera system with a camera CAM, which provide 2D-images of the furnace interior, i.e. inner furnace space 10, wherein the 2D-image is a thermal image. One or more camera systems, this is in particular a number of cameras CAM, can be used for a method of monitor and/or control as will be described below in detail.

The furnace superstructure 12 among others comprises a batch opening 14 or other kind, forms and devices for material supply and a heating device or the like for heating the material. In particular, in this and other embodiments the heating device is formed as burner arrangement 16 with a group of burners and burner ports, oxidiser inlet and combustion products outlet 18. Also, other kinds and forms of heating devices can be provided. Further the furnace structure 12 provides a bubbling system (below the melt level, not shown) which is known in the art to be adapted for creating a controlled disturbance in the glass melt; air or other gases are blown through special bubbler nozzles into the furnace.

In the thermal furnace image 1B of FIG. 1B one can select a picture point A₀ as an example. As will be described with FIG. 4A to FIG. 4C in detail a picture point A₀ with regard to A₀=A(i₀, j₀) is an example of a number or multitude of points. One can automatically select any group of points A_G (as will be described with FIG. 5A, FIG. 5B in detail).

A read out of this picture point A₀ (or multitude of points A_G as shown in FIG. 5A, FIG. 5B) or any other picture point of the furnace image 1A is subject of the fact that related with the picture point A₀, A_G is a camera pixel. In other words an image point (i, j) of the image (more precisely the coordinates (i,j) of the point), in particular the pixel image A(i, j), corresponds to an object-image position assigned to an object location (x, y, z) of an object in the furnace space B(x, y, z), wherein the image point is related with a sensor point of the camera sensor CAM_S.

Thus, the sensor point of the camera sensor CAM_S can be used to determine a physical value (like temperature) for the inner furnace space 10. The physical value (like temperature) can be stored with its value and coordinates (i,j) of the point in the database with time information t₁, when the image was taken in a series SER in a course of time of operation of the furnace 1.

Obviously the picture of a visible furnace image 1A of FIG. 1A, i.e. in the visible range, is only of limited use in this regard—the thermal furnace image 1B of FIG. 1B, i.e. in a thermal range, i.e. infrared or far-infrared range (IR or FIR range), as shown in FIG. 1B is a better instrument in this regard.

An example of the selection of the group of points taken by thermal imaging camera is shown only as an example in FIG. 1B, wherein the thermal image as a furnace thermal image 1B show a group of selected points around the burner ports of the burner arrangement 16.

An image of a series of a furnace thermal image 1B is provided by means of a camera sensor CAM_S of a camera CAM, the camera CAM being installed at the furnace 1 with a camera view to the furnace space 10. Above mentioned example shows seven selected points of temperature measurements Ti (T1, T2 . . . T7), where temperature Tᵢ can be identified from the furnace thermal image 1B in the course of time tᵢ (t₁, t₂, . . . tₙ) and data can be organized in the matrix form as e.g. shown in:

TABLE I
Data structure for group of points defined in FIG. 1B.

Time

| Point | t₁ | t₂ | . . . | tₙ |
|---|---|---|---|---|
| T1 | T₁(t₁) ° C. | T₁(t₂) ° C. | . . . | T₁(tₙ) ° C. |
| T2 | T₂(t₁) ° C. | T₂(t₂) ° C. | . . . | T₂(tₙ) ° C. |
| T3 | T₃(t₁) ° C. | T₃(t₂) ° C. | . . . | T₃(tₙ) ° C. |
| T4 | T₄(t₁) ° C. | T₄(t₂) ° C. | . . . | T₄(tₙ) ° C. |
| T5 | T₅(t₁) ° C. | T₅(t₂) ° C. | . . . | T₅(tₙ) ° C. |
| T6 | T₆(t₁) ° C. | T₆(t₂) ° C. | . . . | T₆(tₙ) ° C. |
| T7 | T₇(t₁) ° C. | T₇(t₂) ° C. | . . . | T₇(tₙ) ° C. |

FIG. 2 depicts a general control strategy 20C for operation of an industrial furnace 1 for processing a heated material M using conventional sensors S. For the control unit CU, yr defines the desired process response, yp the real process response and u the process input which also is considered as a control signal. This general control strategy using conventional sensors S however exhibits significant shortcomings. This is because these sensors S measure the control parameters D values as depicted therein in only a limited number of locations (e.g., several thermocouples for temperatures Tᵢ as indicated above). The critically important process data D such as internal thermal situation, batch shape and melting rate, flame shape and chemistry, or process parameters P, which need to be controlled are represented only partially by the measurement. The control unit CU in this case comprises a standard PID controller. Consequently, the conventional techniques provide only a limited control solution. It is currently possible to record a Temperature/Time function (T over t) for temperature values T measured in the course of time t as shown in FIG. 1B as a data set and attempt to use it for the control purposes. However, there are critical shortcomings of this method preventing its use for the consistent and reliable control as follows.

A first important problem is resided in a mismatch of measurement points due to camera movement; this aspect is the part of the major object addressed by the inventive concept. The camera CAM is installed at the furnace with a camera view to the furnace space 10. More particular the camera CAM having a camera position and/or being directed to the furnace space with a camera orientation, wherein a camera pose CAM_P is assigned to the position and/or orientation of the camera CAM.

The objective of the control (such as temperature control) is to maintain certain real part of the furnace at predefined set point value. This could be for example group of seven points of a temperature measurement by thermal imaging as shown in FIG. 1B, which represents among others a situation around the furnace port of the burner arrangement 16. The corresponding data structure is shown as an example in Table I.

These points, selected in the image, correspond to actual locations within the real 3D space of the furnace interior, i.e. the inner furnace space 10.

The camera projects these 3D locations (x, y, z) as points in 2D-image with no information on its perspective or (in other words) camera view CAM_V; this is due to camera position and/or camera orientation also referred to as camera pose CAM_P.

It can be assumed that for a fixed camera position and no changes in optical settings, these points of temperature measurements Ti (1=1 . . . 7, . . . N) in the 2D-image represent always the same locations of objects in the furnace, i.e. the inner furnace space 10. In this case, such selected points of temperature measurements Ti can be used for the control purposes, because the data D recorded are consistent with respect to their location of objects whose temperature is to be determined.

Whereas the camera CAM having a camera position and/or being directed to the furnace space with a camera orientation, wherein a camera pose CAM_P is assigned to the position and/or orientation of the camera, it has been, however, discovered with the approach of the inventive concept that in case of a real furnace and its operations the camera pose CAM_P is not stable due to the various ambient conditions like e.g. operational disturbances such as camera holder mechanical instability, camera maintenance and cleaning, reproducibility of the camera positioning, camera and lens replacement, etc. This is the process faces inevitably a varying camera pose in the course of time t.

In other words, the camera view CAM_V is subject to a camera view variation ΔCAM_V in the course of time t, in particular due to ambient conditions of the furnace, such that the camera view variation ΔCAM_V causes a deviation of an image point from an object-image position. In particular therein with varying camera pose CAM_P in the course of time t the image point deviates from an initially corresponding object-image position—the result will be described in detail with FIG. 4A, FIG. 4B and FIG. 4C.

The true problem is, that these disturbances cause slight changes in the camera position and/or orientation CAM_P, so that the alignment between the 3D locations in the furnace, respectively inner furnace space 10, and corresponding points in the 2D-image is mismatched. Therefore, the points in the 2D-image, which are fixed by the initial selection are corresponding to other locations in the real furnace interior each time when the camera position and/or orientation -and thus the camera view CAM_V—is changed. In essence, every such camera position and orientation change means a change in the location inside the furnace interior, which is measured for control purposes. This is with varying camera pose CAM_P in the course of time t an image point deviates from the corresponding object-image position.

This results in a mismatch in measured data consistency and therefore prevents an effective furnace control—the inventive concept proposes to improve the control strategy 20C to an improved control strategy 20A, 20B as shown in examples of embodiments in FIG. 10A and FIG. 10B.

It can be shown, that even a slight change in the camera position and/or orientation can cause due to the camera view variation ΔCAM_V a significant mismatch between the original alignment between the 3D locations in the furnace and corresponding points in the 2D-image and the actual alignment.

As has been recognized with the inventive concept the root of this problem is found to be severely impacted with the furnace size and geometry together with observation from one single point of camera view CAM_V. Thus, the concept of the invention starts from the condition that an image point (i, j) of a pixel image A(i, j) corresponds to an object-image position assigned to an object location (x, y, z) of an object B(x, y, z) in the furnace space (x,y,z).

The problem solved is explained in more detail in FIG. 3A to FIG. 3C. The typical furnace chamber dimensions, i.e. dimensions of a furnace crown 11 and dimensions of a furnace material basin 13 in the inner furnace space 10 are: Length 5 m-50 m, width 2 m-12 m and height 1 m-6 m.

The camera(s) is (are) typically located in the opening(s) through one (or more) of the furnace walls. The schematic geometrical representation is shown in FIG. 3A.

Therein a schematic geometrical representation of the furnace and camera position is given. FIG. 3A shows the situation when the camera CAM with a camera sensor CAM_S is located at the furnace 1, this is with a camera view CAM_V to the inner furnace space, wherein mostly the camera CAM is inside the furnace with length L, wherein the camera is located at the wall at the height h above the furnace floor (or melt surface) aiming down at the angle alpha with viewing angle 2×beta; i.e. the camera CAM having a certain camera pose CAM_P to gain the camera view CAM_V. In this case, at given angles alpha and beta 2D-image will display area of the furnace floor (or melt surface) between points x1 and x2 around central point c which is in the middle of the camera field of view.

An example of FIG. 3B illustrates how significantly the position of given observed point x1—this can be an object location (x, y, z) of an object in the furnace space 10—changes with a camera view variation ΔCAM_V; in this case exemplified by a small change of camera inclination angle alpha. Therein a variation of given observed point x1 position with camera inclination angle is shown. In this example, the dimensions are: L=35 m, h=1.9 m, beta=30 deg and alpha varying from 34.16 deg to 33.14 deg. It can be seen, that a very slight change in the camera inclination angle leads to a very significant shift of the observed point, i.e., one degree in the angle alpha results in shift of 8.5 m in the real furnace. Similar adverse effects as with inclination angle are obtained if the position of camera is shifted alongside the x, y, z axis or by any other angular orientation change within the spherical coordinates.

It is obvious that such sensitivity to camera position and orientation CAM_P without additional treatment prevents effective furnace control in scheme of control 20C.

A second problem is resided in the errors of the camera optical system; this aspect is part of the object addressed by a development of the inventive concept. Optical distortions such as vignetting, barrel distortion etc. are related to camera optical system. Vignetting is influencing the radiation intensity impacting on the camera sensor and thus creating artifacts of the thermal imaging. Barrel and pincushion distortions contribute further to the mismatch of measuring points, as explained before.

A third problem is resided in the image obstruction by the furnace atmosphere deposits; this aspect is part of the object addressed by a development of the inventive concept. Further, a complication for the furnace imaging is caused by the deposits blocking camera view in the form of stalagmites in front of the camera or directly depositing on camera lens creating fogging. These deposits are created by condensation of the volatile species from the furnace atmosphere and/or by settling of solid particles. Specifically, undetected fogging makes thermal imaging inadequate while deposits blocking camera view make measurement impossible. These effects can happen only at part of the image and the current state of art technology cannot identify them and compensate their influence.

A fourth problem is resided in the various area size of the furnace displayed on one pixel; this aspect is part of the object addressed by a development of the inventive concept. The further complexity arises from the fact that each pixel within an image A(i, j) is corresponding not to a discrete point inside the furnace, but is representing an area which size depends on the distance from the camera and on the angle of view.

FIG. 3C provides a relation between the length of the displayed furnace floor by one pixel of the camera sensor as a function of the distance of this point from the camera. Vertical pixel resolution is 1080 pixels per viewed area. FIG. 3C illustrates the case for dimensions of L=35 m, h=1.9 m, alpha=33.14 deg, beta=30 deg. It can be seen that, e.g., the length of floor (or surface of melt M) element displayed on one pixel dx significantly vary with the distance x from the wall where the camera is installed.

Generally, a method of monitor and/or control of operation of an industrial furnace for processing a heated material is applied to an industrial furnace. As described herewith the industrial furnace is adapted for processing a melt in a melting end of a kiln or the like industrial furnace 1. The industrial furnace has an inner furnace space 10 comprising a furnace crown 11, a furnace superstructure 12 and a furnace material basin 13. The method provides the steps of:
an image process of at least a part of the furnace space is provided, namely provided with a series of images 1B in the course of time,
wherein an image of the series is provided by means of a camera sensor CAM_S of a camera CAM, the camera CAM being installed at the furnace with a camera view CAM_V to the furnace space 10. In particular it can be assumed that with the camera having a camera position and/or being directed to the furnace space with a camera orientation, therein a camera pose CAM_P is assigned to the position and/or orientation of the camera.

Therein the image 1B is provided as a pixel image A(i, j) with a number of image points (i, j), wherein an image point is assigned to a sensor pixel of the camera sensor CAM_S. The image of the furnace space 10 is related to a technical map of at least one process parameter P of the furnace space during operation of the furnace by means of an image point read out, i.e. at a sensor pixel of the camera sensor CAM_S. Therein a process parameter P is used in the monitor and/or control of operation of the furnace.

In the following at first an exemplifying description is given as how to provide an improved method and control scheme—as explained in detail with FIG. 10A, FIG. 10B, FIG. 11 and FIG. 12—, namely in that a varying camera pose CAM_P in the course of time tᵢ (i=1 . . . n , wherein tᵢ indicate a series of points of time), can be applied for by image analysis as such. Thus, the concept of invention is unlike sophisticated modelling of the changes to the setting of camera and furnace.

The approach of inventive concept is to provide a deviation-compensation to the object-image position in the actual image 1B to apply for a camera view variation ΔCAM_V. More particularly due to the varying camera pose CAM_P this is considered to be particular useful. In order to overcome the shortcomings of the present state of art, this invention concept proposes a new method how to use camera imaging in furnace control as explained with FIG. 10A, FIG. 10B, FIG. 11 and FIG. 12—.

As explained above, the concept of the invention starts from the condition that an image point (i, j) of a pixel image A(i, j) corresponds to an object-image position assigned to an object location (x, y, z) of an object B(x, y, z) in the furnace space (x,y,z).

In a preferred embodiment the first important problem is resided in a mismatch of measurement points due to a camera movement. As addressed as follows to overcome the errors resulting from the camera movement is part of the major object and thus is addressed by the inventive concept. A good exemplifying non-restrictive solution within the concept of the invention is to apply for the mismatch of measurement points due to camera movement given as follows.

### Introduction of the Transformation function

With view to FIG. 4A it is to be understood, that in case that any point of interest within the furnace interior (furnace space coordinates (x, y, z) can be chosen arbitrarily as intended for control purposes using the camera imaging, its projection in the 2D-image—namely the mage coordinates (i, j)—are selected. The present invention introduces a transformation function T such that to each point (i, j) within the 2D-image—captured by the camera—assigns a point inside the furnace interior (x, y, z) within the camera field of view:

A(i, j)→T.B(x, y, z); (1)

### Where:

A(i, j) is a 2D-matrix of points within the 2D-image;
B(x, y, z) is a 3D-matrix of points inside 3D-furnace space displayed within the camera field of view;
T is the transformation function.

Thus, it can be said, that an image point (i, j) of the pixel image A(i, j) corresponds to an object-image position assigned to an object location (x, y, z) of an object B in the furnace space B(x, y, z).

The transformation function can be described by the following expressions:

$$T ( x , y , z ) = T ( f ( i , j ) , g ( i , j ) , h ( i , j ) ) ; \qquad ( 2 )$$

$$x = f ( i , j ) ; y = g ( i , j ) ; z = h ( i , j ) ; \qquad ( 2 - 1 , 2 - 2 , 2 - 3 )$$

### Where:

f(i, j), g(i, j), h(i, j) are the functions expressing the alignment between the coordinates [i, j] of points within the 2D-image A(i, j) and furnace space coordinates [x, y, z].

In case the camera position is not changed the alignment is matching, i.e., the transformation function T remains unchanged, and any point within the image can be used for control; the original position A₀=A(i₀, j₀) of the selected control point within the image will always correspond to location B₀ in this hypothetical case.

With view to FIG. 4B it is to be understood, that with varying camera pose in the course of time however, the image point (i, j) deviates from the corresponding object-image position. Thus, on the other hand, in case that camera position or orientation changes, the transformation function is changed to Tn and the original position A₀=A(i₀, j₀) of the selected control point within the image will correspond to other location B1 inside the furnace as shown by development from the image shown in FIG. 4A to FIG. 4B.

Therefore, after the camera position or orientation change ΔCAM_V, the following relation is valid:

A(i, j)→Tn.B(x, y, z); (3)

### Where:

A(i, j) is a 2D-matrix of points within the 2D-image;
B(x, y, z) is a 3D-matrix of points inside 3D-furnace space displayed within the camera field of view;
Tn is the new transformation function after change of the camera position or orientation.

Severity of the problem is obvious from the example when a camera inclination angle alpha (see FIG. 3A) changes by 1 degree, the representation of the position of point x1 is shifted by 8.5 m further from its original location in the furnace (see Fehler! Verweisquelle konnte nicht gefunden werden.). This effectively means that the measurement is conducted 8.5 m far away from the originally selected point within the furnace.

The invention solves the above-mentioned problem using transformation function as described in the following below.

### Selection of the Control Point in the Furnace and its Representation the 2D-Image

Originally selected control point B₀ in the furnace B(x₀, y₀, z₀) has coordinates (x₀, y₀, z₀)—see FIG. 4A which depicts a schema of the 3D-furnace space FS3 (on the left) and the corresponding projection furnace space FS2 thereof into the 2D-image of the 3D-furnace space, i.e. projection thereof (on the right) taken by the camera at initial pose. In the initial state, a point in the furnace B(x₀, y₀, z₀) (hereinafter B₀) corresponds to the image point A(i₀, j₀) (hereinafter A₀) and the following relation applies:

A(i₀, j₀)→T0.B(x₀, y₀, z₀); (4)

### Where:

A(i₀, j₀)=A₀ is the control point with coordinates [i₀, j₀] within the 2D-image corresponding to the point B₀=B(x₀, y₀, z₀);
B(x₀, y₀, z₀)=B₀ is the initially selected control point with coordinates [x₀, y₀, z₀] inside 3D-furnace space within the camera field of view;
T0 is the initial transformation function.

In this regard, so to say, a characteristic object-image position A₀ for an object B₀ is identified in the reference image at time t₀ for an object B₀ at an object location (x₀, y₀, z₀) of an object in the furnace space (B(x, y, z)) as shown in right part of FIG. 4A. Such situation can be provided in a reference image IMG_ref according to the concept to the invention and as described below in an example.

So to say in the image provided in FIG. 4A on the right hand side, a number of image points (i, j), in particular in a pixel image therein, an image point (i, j) is assigned to a sensor point, in particular sensor pixel (i, j), of the camera sensor CAM_S.

### Drift of the Measured Point Representation Caused by the Camera Movement

After the change of camera position or orientation the initially selected control point A₀=A(i₀, j₀) corresponds to another point inside 3D-furnace space B(x₁, y₁, z₁)=B₁; this is A₀=A(i₀, j₀) now corresponds to B₁ as the another point inside 3D-furnace space—the same camera pixel formerly aiming to B₀ now with changing camera view aims to B₁—see FIG. 4B which depicts a schema of the 3D-furnace space (on the left) and the corresponding 2D-image (on the right) taken by the camera after a change of its orientation—and the following relation applies:

A(i₀, j₀)→Tn.B(x₁, y₁, z₁); (5)

### Where:

A₀=A(i₀, j₀) is the originally selected control point with coordinates [i₀, j₀] within the 2D-image;
B₁=B(x₁, y₁, z₁) is the new point in the furnace with coordinates [x₁, y₁, z₁] corresponding to the image point A₀=A(i₀, j₀);
Tn is the new transformation function (where index n=1, 2, . . . , k identifies the new transformation function after each change of the camera position and/or orientation).

Such situation e.g. can be provided in an actual image IMG_act according to the concept to the invention and as described below. In this regard, so to say (i₀, j₀) is related to the originally selected control point.

### Compensation of the Drift

A characteristic object-image position A₀ referring to object location B₁ is identified in the actual image IMG_act and a corresponding characteristic object-image position A₀ referring to object location B₀ is identified in the reference image IMG_ref. In order to continue to measure the initially selected control point B(x₀, y₀, z₀)=B₀, the new coordinates within the 2D-image [i₁, j₁] must be determined—see FIG. 4C which depicts a schema of the 3D-furnace space (on the left) and the corresponding 2D-image (on the right) showing correction performed by using the inverse transformation function T1-inverse—for which the following relation applies:

B(x₀, y₀, z₀)→T1-inverse.A(i₁, j₁); (6)

### Where:

B₀=B(x₀, y₀, z₀) is the initially selected control point with coordinates [x₀, y₀, z₀] inside 3D-furnace space within the camera field of view;
A₁=A(i₁, j₁) (now related with B₀) is the corresponding new control point with coordinates (i₁, j₁) within the 2D-image as shown in FIG. 4B and FIG. 4C;
T1-inverse is an inverse function to the new transformation function T1.

Generally, the inverse transformation function T-inverse can be described by the following expressions:

$$T - inverse ( i , j ) = T ( u ( x , y , z ) ; v ( x , y , z ) ) ; \qquad ( 7 )$$

$$i = u ( x , y , z ) ; j = v ( x , y , z ) ; \qquad ( 7 - 1 , 7 - 2 )$$

### Where:

u(x, y, z) and v(x, y, z) are the functions expressing the alignment between the furnace space coordinates [x, y, z] and the coordinates [i, j] of points within the 2D-image A(i, j);
T is the transformation function.

Such situation can be considered as a deviation ΔPOS identified for a characteristic object-image position A₁ in the actual image IMG_act as compared to the characteristic object-image position A₀. More precisely the characteristic object-image position A₁ in the actual image IMG_act is now the object-image position A₀ referring to object location B₁ as the aiming of the respective camera pixel changed with changing camera view CAM_V at time t₁. in the actual image IMG_act as compared to the characteristic object-image position A₀. More precisely the object-image position A₀ refers to object location B₀ as the original aiming of the respective camera pixel with original camera view CAM_V at time t₀ in the reference image IMG_ref; this is according to the concept to the invention and as described below.

### Periodic Alignment Correction Procedure

The above mentioned procedure according to sections “Drift of the measured point representation caused by the camera movement” and “Compensation of the drift” (B₁=B(x₁, y₁, z₁) related to A₀=A(i₀, j₀) at time t₁—actual image IMG_act) can be applied whenever a deviation from the original alignment between B₀=B(x₀, y₀, z₀) and A₀=A(i₀, j₀) at time to (reference image IMG_ref) as defined by Eq. 4 is detected.

Thus, a deviation-compensation can provided to the object-image position in the actual image (A(iₙ, jₙ)) (FIG. 4C), to apply for the varying camera pose, wherein the deviation-compensation is based on a deviation identified for a characteristic object-image position in the actual image as compared to the reference image.

### Determination of the Transformation Function

The alignment between the 2D-image and the 3D-furnace space is described by means of the transformation function as described in Eq. 1. The present invention uses image analysis for finding the initial alignment between the points within the furnace space B(x, y, z) and the points within the 2D-image A(i, j). The image analysis employs for example but not limited to methods of edge detection, image feature extraction and matching, segmentation by use of Neural Networks, genetic algorithms.

The following procedure discloses use of automated image analysis employing techniques of segmentation and Neural Network-based object identification within the image.

FIG. 5A shows a reference image IMG_ref with a glass level of melt M and examples of identified arbitrary points A of interest indicating mostly the structure of the furnace; i.e. those points with original alignment between B₀=B(x₀, y₀, z₀) and A₀=A(i₀, j₀) at time t₀—reference image IMG_ref. More particular a group of points A_G is shown therein.

A point is denoted as a point A of interest as it has some feature identifiable and distinguishable from its nearest surrounding. This distinguishable feature is identifiable e.g. by one or more of the features selected from the group consisting of: high or extreme gradient of contrast, high or extreme gradient of luminance, extremely low or extremely high intensity, change of colour. The gradient or change or extreme can be present as a pixel-to-pixel gradient or change or extreme.

This kind of distinguishable feature is understood regularly to denote some interesting structure or line in the image like a border between melt and/or furnace crown and/or furnace structure or an item of the superstructure. Such kind of points of interest are understood mostly in that they can be considered as fixed as compared to moving parts (melt, batch, flame) of the furnace interior when the furnace is in operation. Thus, a point A of interest is best suited to have a characteristic object-image position assigned to an object location of the object.

The points A of interest can be selected arbitrarily in that they can be selected in various areas of the image and at best somewhat distributed over the image; if not distributed uniformly (which is unlike) but distributed accurately to balance out the various deviation ΔPOS identification for the characteristic object-image position in the actual image as compared to the characteristic object-image position in the reference image for each point of interest. In that sense the points A of interest can be understood to be selected “arbitrarily”.

Said deviation ΔPOS is understood to be different for each pair of a point A of interest in the actual image and reference image and this depending on where the point A of interest is located in the image. Thus, an average of all deviations ΔPOS identified will be better, the more accurate the distribution is; thus to balance out the various deviations ΔPOS and come to a good value for ΔPOS.

In other words, when identifying some points A of interest in the reference image, only part of them will be found in the actual image. This is also visible in comparing the right and left part of FIG. 5B.

FIG. 5B depicts a comparison of the reference image (reference image IMG_ref on the right) with the actual image IMG_act (on the left) as a basis for transformation function Tn determination. Some of the identified points of interest A₀ originally corresponding to characteristic objects B₀ image-locations in the reference image IMG_ref at the time t₀—denoted as A₀→[B₀, t₀]—are later found at image-locations A₁ in the actual image IMG_act at the time t₁—denoted as A₁→[B₀, t₁]—. In other words, A₀ and A₁ indicate one and the same object B₀=B(x₀, y₀, z₀) at time t₁ and t₀ respectively. Therefore, transformation function Tn can be derived from the relation between A₀ and A₁.

To illustrate an alternative or additional approach based on the same approach, FIG. 6 shows the edges A_E of visible objects inside the furnace identified by image analysis. Two consequent images (reference image on the right and the actual image on the left) serve as a basis for transformation function Tn determination.

To illustrate an alternative or additional approach, FIG. 7 shows fixed objects (red—furnace superstructure, blue—melt level, grey—observation hole edges) inside the furnace identified by means of neural network; neural identified objects A_N-serve as a basis for determination of the transformation function Tn.

### Reference Image Creation

In the first step of the core process according to the concept of the invention a reference image IMG_ref (A_{reference}(i, j)) of the furnace space B(x, y, z) is provided at an initial (point of) time in the course of time. Thus a reference image IMG_ref is taken (see FIG. 5A, FIG. 6, FIG. 7) by the camera CAM at an initial position and orientation CAM_P and thus camera view CAM_V resulting therefrom as explained above. The matrix of image points A_{reference}(i, j) correspond to points within the 3D-furnace space B(x, y, z).

A_{reference}(i, j)→T0.B(x, y, z); (8)

### Where:

A_{reference}(i, j) is the matrix of points of the reference image;
B(x, y, z) is a 3D-matrix of points inside 3D-furnace space displayed within the camera field of view;
T0 is the initial transformation function.

### Reference Image Analysis

In the second step of the core process according to the concept of the invention, an image point (i, j) of the pixel image A(i, j) corresponds to an object-image position assigned to an object location (x, y, z) of an object in the furnace space B(x, y, z). More particularly the reference image (A_{reference}(i, j)) of the furnace space B(x, y, z) is provided at the further (point of) time t₀ in the course of time, and a characteristic object B₀ in the furnace space B(x₀, y₀, z₀) is selected at the initial time t₀, wherein the characteristic object-image position A₀ [B₀, t₀] of this characteristic object B₀ at time t₀ corresponds to an original image point (i₀, j₀) in the reference image A(i₀, j₀) (FIG. 4A). It can be said, that a characteristic object-image position A₀ [B₀, t₀] is identified at original image point (i₀, j₀) in the reference image A(i₀, j₀).

Thus, points of interest A, A_G, A_E, A_N as indicated for example in FIG. 5A, FIG. 5B and FIG. 6 and FIG. 7 respectively can be related with object-image positions assigned to respective objects and these points of interest A, A_G, A_E, A_N comprising the object-image positions within the 2D reference image are identified by an automated image analysis procedure. Output of this procedure constitutes a set of reference image characteristics and the determined transformation function T0.

In case that the arbitrary points or objects are fixed within the furnace 3D space, e.g., objects which are parts of the furnace superstructure, complete glass level etc., the relation expressed in Eq. 8 can be approximated by a simplified form using relationship between two images taken at different time:

A_{reference}(i, j)=Tn.Aₙ(i, j); (9)

### Where:

A_{reference}(i, j) is the reference image and;
Aₙ(i, j) is the actual image;
Tn is the actual transformation function.

A position of the fixed object in the images is then identified as:

A_{reference}(iF_{reference}, jF_{reference})=Tn.Aₙ(iFₙ, jFₙ); (10)

### Where:

A_{reference}(iF_{reference}, jF_{reference}) is the position of the fixed object image identified by image analysis in the reference image;
Aₙ(iFₙ, jFₙ) is the position of the fixed object identified by image analysis in any other image;
Tn is the actual transformation function.

From the relation between A_{reference} and Aₙ, prescription for the inverse transformation function Tn-inverse is derived in the form:

Aₙ(iₙ, jₙ)=Tn-inverse. A_{reference}(iF_{reference}, jF_{reference}); (11)

### Where:

A_{reference}(iF_{reference}, jF_{reference}) is the position of the fixed object image identified by image analysis in the reference image;
Aₙ(iₙ, jₙ) is the position of the fixed object image in the actual image;
Tn-inverse is the actual inverse transformation function.

The inverse transformation function Tn-inverse can be described by the following expressions:

$$Tn - inverse ( i , j ) \approx T ( f ( {iF}_{reference} , {jF}_{reference} ) ; g ( {iF}_{reference ,} {jF}_{reference} ) ) \qquad ( 11 )$$

$${i}_{n} \approx f ( {iF}_{reference} , {jF}_{reference} ) ; {j}_{n} \approx g ( {iF}_{reference ,} {jF}_{reference} ) ; \qquad ( 11 - 1 ; 11 - 2 )$$

### Where:

iₙ and jₙ are the coordinates of the fixed object image in the actual image corresponding to the original position of the same object image in the reference image before camera pose change;
iF_{reference} and jF_{reference} are the coordinates of the fixed object image in the reference image;
f and g are inverse transformation functions of (i, j) coordinates between the actual and the reference image. These functions are applied by means of interpolation/extrapolation.

In other words an actual image (A(iₙ, jₙ)) is provided at a further time (FIG. 4B) during the course of time. As explained above a characteristic object-image position is identified in the actual image and a corresponding characteristic object-image position is identified in the reference image.

The invention recognized that due to the course of time the camera view is subject to a camera view variation in the course of time, in particular due to ambient conditions of the furnace, such that the camera view variation ΔCAM_V causes a deviation of the image point from the object-image position, in particular wherein with varying camera pose in the course of time the image point (i, j) deviates from the corresponding object-image position.

### Determination of the Object-Image Position Shift Represented by Transformation Function Tn

In the third step of the core process according to the concept of the invention, an actual image IMG_act (A(iₙ, jₙ)) is provided at a further time (FIG. 4B), and a deviation-compensation is provided to the object-image position in the actual image (A(iₙ, jₙ)) (FIG. 4C), to apply for the varying camera pose, wherein the deviation-compensation is based on a deviation identified for a characteristic object-image position in the actual image as compared to the reference image. More particularly the actual image A(iₙ, jₙ) is provided at the further time t₁ (FIG. 4B), wherein the original image point (i₀, j₀) in the actual image A(i₀, j₀) (FIG. 4B) corresponds to another object-image position A₁ [B₁, t₁]; this is at the further time t₁ the camera's original image point (i₀, j₀) aims to another object B₁ at the further time t₁. Also, the characteristic object-image position A₁ [B₀, t₁] is identified to correspond to another image point (i₁, j₁) in the actual image (A(i₁, j₁)) (FIG. 4C).

Here the points of interest or objects can be identified as A, A_G, A_E, A_N (set of reference image characteristics) in the reference image are automatically searched and identified in all other consequent images—see FIG. 5B, FIG. 6, FIG. 7.

Those fixed points or objects A, A_G, A_E, A_N—which can be identified in both images (i.e., in the reference one and in the actual one) with predefined degree of certainty—are used for determining the actual transformation function Tn according to Eq. 10.

Based thereon thereby a deviation-compensation COMP−ΔPOS is provided to the object-image positions A₁ [B₀, t₁] in the actual image (A(iₙ, jₙ)) (FIG. 4C), to apply for the varying camera pose. Therein the deviation-compensation is based on a deviation identified for a characteristic object-image position A₁ [B₀, t₁] in the actual image IMG_act as compared to the characteristic object-image position A₀ [B₀, t₀] in the reference image IMG_ref.

More particularly the deviation-compensation is provided to the object-image position in actual image (A(iₙ, jₙ)) (FIG. 4C) and applies for the varying camera pose, in that the deviation-compensation is determined by means of identifying a deviation (A(i₀, j₀)−A(i₁, j₁)) between the original image point (i₀, j₀) and the another object image point (i₁, j₁) in the actual image; the relation with the deviation ΔPOS is shown in FIG. 4C.

In other words, it can be said that within the concept of the invention this example shows a preferred way of a method in that
a characteristic object-image position corresponds to an original image point (i₀, j₀) in the reference image A(i₀, j₀) (FIG. 4A) in that an image point (i, j) of the pixel image (A(i, j)) corresponds to the characteristic object-image position and/or
an object-image position is assigned to a characteristic, in particular fixed, object corresponding to one or more selected points of a group or cluster of points of interest, in particular in the reference image (A_{reference}(i, j), FIG. 5A), in particular wherein at least one point of interest in the reference image (A_{reference}(i, j) is selected, (FIG. 5A) such that the point of interest is assigned to the characteristic object and the object-image position of the point of interest is determined as an image point (i, j) of the pixel image (A_{reference}(i, j)).

Further
a characteristic object-image position is identified to correspond to another image point (i₁, j₁) in the actual image (A(i₁, j₁)) (FIG. 4C) as compared to the reference image, wherein at least some of the points of interest are identified in the actual image (A(iₙ, jₙ) (FIG. 5B), and
the deviation (A(i₀, j₀)−A(i₁, j₁)) between the original image point (i₀, j₀) and the another image point (i₁, j₁) in the actual image (FIG. 4C) results from a deviation-relation between at least some of the selected points of interest and is used to determine the deviation-compensation to the object-image position in the actual image (A(iₙ, jₙ)) (FIG. 5B, left part).

The alternative way of selection the objects in the reference image makes use of the edge detection of all distinctly visible objects inside the furnace, such as ports, joints, arches, etc.—see in FIG. 6. These objects are identified together with their numerical descriptors.

Any following image is identified in the same way and its descriptors are compared with those of the reference image. In case a significant difference is found, a new transformation function Tn is found.

Another way of selection the objects in the reference image is based on Neural Network identification of the principal parts of the furnace A_N such as superstructure, glass melt surface, observation holes and similar objects (see FIG. 70). Difference in position of these identified objects in the reference image in comparison to any other consequent image is used for determination of the actual transformation function Tn.

### Determination of the Inverse Transformation Function Tn-Inverse for Drift Compensation

In the fourth step, the deviation of the actual transformation function Tn from the initial transformation function T0 is evaluated. In case the deviation is greater than a predefined threshold, inverse transformation function Tn-inverse is calculated and used for determination of the position of the initially selected control point in the actual image A(i₁, j₁)—see Eq. 6.

### Other Camera Related Corrections for Changes in Camera View

Also the following errors of the camera optical system, image obstruction by the furnace atmosphere deposits, camera blocking by the deposits and camera lens fogging are considered as changes processes which result in changes in camera view as explained in detail below. The changes in camera view can apply to one or more cameras in use for the method of the inventive concept.

### Solution for Errors of the Camera Optical System

It is further beneficial to calibrate and compensate the optical system of the camera for optical errors such as vignetting, barrel or pincushion distortion. Techniques of the calibration and compensation are based on measurement of standard calibration image—here standard calibration image can be compared to effect of barrel and pincushion distortion. The measured deviations caused by the optical errors are quantified and used for image compensation in order to receive an undistorted image. This improved image is preferable for data processing according to procedures described in sections “Solution for mismatch of measurement points due to camera movement” and “Determination of the transformation function”

### Solution for Image Obstruction by the Furnace Atmosphere Deposits

The present invention uses an automated method for identification of either deposits blocking camera view or camera lens fogging.

### Solution for Camera Blocking by the Deposits

The method is based on Neural Network object identification where calibration image with no deposit is recorded. Artificial Neural Network identifies visible objects within the image. Any other consequent image is identified using Neural Network and presence of the deposit including its location is identified. Neural Network is specifically trained such a way that it distinguishes other objects such as bubbling, batch, and flame from the specific of the deposit—see FIG. 8 Original image (left) obstructed by the deposits—see dark corner areas at the bottom of the image. Neural Network analysis of the image (right) shows identified deposits DEP (grey color), and clearly distinguishes these from the batch of material B (ochre), flame F (purple), bubbler BBL (pink), glass melt M (violet), and superstructure 12 (green).

### Solution for Camera Lens Fogging

Fogging identification is based on quantification of the blur index BI where integral of the radiation intensity in the reference image is compared to integral of the radiation intensity in any consequent image. Shown in FIG. 9 is a result of the fogging evaluation together with the reference image IMG_ref and actual image IMG_act: Reference IMG_ref not blurred image (left) and the actual blurred image IMG_act (right). Charts of the blur index BI are shown below the images.

The evaluated blurring index BI can be used for correction of the thermal imaging using a general formula:

I-corrected=I-actual.(1/BI); (12)

### Where:

I-corrected is the corrected radiation intensity value used for thermal imaging;
I-actual is the measured radiation intensity;
BI is the blurring index, which is a number between zero and one indicating the relative attenuation of the radiation intensity by the semi-transparent deposit layer.
The temperature can then be obtained using a general formula:

T-measured=k(I-corrected); (13)

### Where:

T-measured is the measured temperature;
k(I-corrected) is function converting the radiation intensity received by the camera into the temperature taking into account camera thermal calibration and material emissivity;
I-corrected is the corrected radiation intensity value used for thermal imaging.

### Solution for Various Area Size of the Furnace Displayed on One Pixel

It is beneficial to calculate based on known furnace geometry and position and orientation of the camera within the furnace (which is identified from the image analysis by comparing image, known furnace geometry, using, e.g., genetic programming) the physical area of the furnace corresponding to each pixel of the image. This information is used for determination of the precision of the object spatial identification. This is specifically beneficial for identification of the batch, bubbler, flame, temperature of the object.

### New Control Method Using Corrected Camera Imaging

It has been found, based on the concept of the invention, that the furnace control can be greatly improved by the use of the camera CAM and image analysis as described above. The concept recognizes that the camera view is subject to a camera view variation in the course of time, in particular due to ambient conditions of the furnace, such that the camera view variation causes a deviation of the image point from the object-image position,

in particular wherein with varying camera pose in the course of time the image point (i, j) deviates from the corresponding object-image position.

Thus, information from such imaging is processed through several enhancing modules performing at least the following functions:
Correction of the mismatch of measurement points due to camera view variation ΔCAM_V; this is basically due to camera movement, which results in a variation of the camera pose CAM_P.

This correction is basically achieved in that
a reference image (A_{reference}(i, j)) of the furnace space B(x, y, z) is provided at an initial time during the course of time,
an actual image (A(iₙ, jₙ)) is provided at a further time (FIG. 4B) during the course of time,
a characteristic object-image position is identified in the actual image and a corresponding characteristic object-image position is identified in the reference image,
a deviation is identified for the characteristic object-image position in the actual image as compared to the characteristic object-image position in the reference image.
   Determination of the transformation function for correction of the mismatch of measurement points due to camera movement.

This determination of the transformation function basically allows providing a deviation-compensation to the object-image position in the actual image (A(iₙ, jₙ)) (FIG. 4C), to apply for the varying camera view, wherein the deviation-compensation is based on a the deviation identified.

Further enhancing modules performing the following functions have been found to be of particular use with advantages as described above:
Correction of errors of the camera optical system;
Detection and correction for image obstruction by the furnace atmosphere deposits;
Correction for various area size of the furnace displayed on 1 pixel.

The above procedure converts information from the imaging into the reliable and reproducible data, which can be used for dependable furnace control. One or several major features of this data can be achieved at least thereby as listed below:
Measured points are continuously correctly identified in the image always corresponding to the same location in the furnace;
The precision of the points identification is known based on area size of the furnace displayed on 1 pixel.

Further, the optional feature of this data can be achieved in that:
Any image obstruction is identified and automated correction is taken.

Further, the major feature of this data can be achieved in that:
Correct temperature reading can be made using compensation for the image obstruction and correction for the camera optical system errors.

More particular this is due to that the image of the furnace space, which is used for relating into the imaging technical map of process parameters, is determined by means of the deviation-compensated actual image.

Further one or more optional features of this data can be achieved in that:
Batch, foam, bubbling, furnace walls, glass melt level, and flame are identified using automated image analysis (Neural Networks, genetic programming etc.) and their precise location in the furnace is measured as a function of time;
Temperature reading can be further enhanced using known emissivity and analysis of angular radiation components.

This new precise data allow determining at least one or more of new enhanced control parameters as listed below:
Temperature of the furnace superstructure;
Temperature of the glass surface, batch and foam or scum layer;
Temperature of the exhaust ports, exhaust ducts, and regenerators;
Throat area and riser area temperature;
Batch melting rate;
Batch position;
Batch migration patterns and velocity;
Flame chemistry—CO and NOₓ generated by combustion;
Identification of the flame hot zones;
Refractory corrosion, cracking or dis-integration;
Refractory overheating.

These new enhanced control parameters are very beneficial for new level of the furnace control with either conventional control approach—see FIG. 10A—or with usage of model based predictive control—see FIG. 10B.

Thus, the conventional control as described in FIG. 2 is modified and new process parameters as described above are used. In this regard, FIG. 10A, and FIG. 10B depict a general control strategy using conventional sensors S. However, therein yr* defines the desired process response of improved kind, yp* the improved process response and u* the improved process input which also is considered as a control signal. Thus, the general control strategy using conventional sensors S measuring the control parameters values as depicted therein in only a limited number of locations (e.g., several thermocouples) is improved as follows. The critically important process data D* such as internal thermal situation, batch shape and melting rate, flame shape and chemistry, or parameters are controlled in an improved way according to the concept of the invention; this is they are partially represented by the (conventional) measurement and partly by the (inventive) camera based monitor and/or control of operation of the industrial furnace. As a result the improvement provides that the conventional techniques go beyond a limited control solution. Corrected camera imaging results I* are received and used for enhanced process parameters P*. The enhanced process parameters P* are used in the control scheme as shown in FIG. 10A, and FIG. 10B—this is, they are fed back to control the furnace 1 as the improved process response yp* in addition to the conventional process response yp; thus this results in a new improved process output yem*.

The improvement is executed by the inventive control system 100 as is described below with FIG. 11 and FIG. 12. The inventive control system 100 exhibits a camera K, an image taking module 130, a read out module 110 and a deviation-compensation module DELTA which gives data to a control unit 120; an image of the furnace space which is used in a read out module 110 for relating into the imaging technical map of process parameters is determined by means of the deviation-compensated object-image position in the actual image.

The inventive control system 100 allows for gaining the corrected camera imaging results I* to be received and used for enhanced process parameters P* as shown in FIG. 10A, and FIG. 10B. Implementation thereof in the control loop as shown in FIG. 10A, and FIG. 10B with the enhanced process response and new process output yem* provides an improved, i.e. desired enhanced process response yr*.

FIG. 11 depicts a scheme of an industrial furnace 1 for processing a heated material M, in particular for processing a melt in a melting end of a kiln or the like industrial furnace 1, wherein the industrial furnace has an inner furnace space 10 comprising a furnace crown 11, a furnace superstructure 12 and a furnace material basin 13 and further comprising the control system 100 adapted to execute the method of the inventive concept. Further an inventive control system 100 is connected to at least the structural actuator elements as shown in FIG. 11, which serve to supply air or the like oxidizer and fuel to the furnace space 10.

The inventive control system 100 preferably further provides for a camera CAM adapted in that
an image process of at least a part of the furnace space is provided, namely provided with a series SER of images in the course of time tᵢ,
wherein an image of the series SER is provided by means of a camera sensor CAM_S of the camera CAM, the camera being installed at the furnace 1 with a camera view CAM_V, i.e. position and/or directed to the furnace space with a camera orientation wherein a camera pose CAM_P is assigned to the position and/or orientation of the camera CAM. The setting has been further exemplified with FIG. 1A and FIG. 1B and FIG. 10A and FIG. 10B and the same reference signs are used in this regard. The series SER of images is taken by an image taking module 130 and a read out module 110 is provided as illustrated below.

Therein, an image 1B is provided as a pixel image (A(i, j)) with a number of image points (i, j), wherein an image point is assigned to a sensor pixel of the camera sensor CAM_S. An image point (i, j) of the pixel image A(i, j) corresponds to an object-image position assigned to an object location (x, y, z) of an object in the furnace space B(x, y, z);

The inventive control system 100 preferably further provides for the read out module 110 adapted in that

the image of the furnace space is related to a technical map of at least one process parameter of the furnace space during operation of the furnace by means of an image point read out, and
a control unit 120 is adapted in that
a process parameter P* is used in the monitor and/or control of operation as shown in FIG. 10A and FIG. 10B.

It can be assumed that with varying camera view CAM_V due to varying camera pose CAM_P in the course of time the image point (i, j) deviates from the corresponding object-image position.

The inventive control system 100 preferably further provides for the image taking module 130 adapted in that
a reference image (A_{reference}(i, j)) of the furnace space B(x, y, z) is provided at an initial time
an actual image (A(iₙ, jₙ)) is provided at a further time (FIG. 4B).

The inventive control system 100 preferably further provides for a deviation-compensation module DELTA adapted in that
a deviation-compensation is provided to the object-image position in the actual image (A(iₙ, jₙ)) (FIG. 4C), to apply for the varying camera view ΔCAM_V and pose ΔCAM_P, wherein the deviation-compensation is based on a deviation identified for a characteristic object-image position in the actual image as compared to the reference image.

The control unit 120, CU is further adapted in that
the image 1B of the furnace space 10 which is used for relating into the imaging technical map of process parameters P* is determined by means of the deviation-compensated object-image positions in the actual image.

Thus an industrial furnace 1 for processing a heated material M, in particular for processing a melt in a melting end of a kiln or the like industrial furnace, is shown herewith, wherein the industrial furnace has an inner furnace space 10 comprising a furnace crown, a furnace superstructure and a furnace material basin and comprising a control system 100 as described hereinbefore and/or adapted to execute the method as described hereinbefore.

The industrial furnace can be formed as a

a glass furnace with a furnace space comprising a furnace crown and a superstructure over a material basin with a glass melt, and/or with the control applying to control of a high temperature process.

FIG. 12 shows a view graph to illustrate a corresponding method 1000 of monitor and/or control of operation of an industrial furnace for processing a heated material, in particular for processing a melt in a melting end of a kiln or the like industrial furnace, wherein the industrial furnace has an inner furnace space comprising a furnace crown, a furnace superstructure and a furnace material basin as described above with FIG. 1A, FIG. 1B and FIG. 10A, FIG. 10B. In the method 1000:
in step 1100 an image process of at least a part of the furnace space 10 is provided, namely provided with a series SER of images in the course of time tᵢ,
wherein an image 1B of the series SER is provided by means of a camera sensor CAM_S of a camera CAM, the camera CAM being installed at the furnace 1 with a camera view CAM_V to the furnace space 10,
   in particular with the camera having a camera position and/or being directed to the furnace space with a camera orientation, wherein a camera pose CAM_P is assigned to the position and/or orientation of the camera.

Therein in step 1200 the image IMG is provided as a pixel image (A(i, j)) with a number of image points (i, j), wherein an image point is assigned to a sensor pixel of the camera sensor CAM_S,
and the image of the furnace space is related to a technical map MAP of at least one process parameter of the furnace space during operation of the furnace by means of an image point read out. Therein a process parameter P is used in the monitor and/or control of operation.

An image point (i, j) of the pixel image A(i, j) corresponds to an object-image position assigned to an object location (x, y, z) of an object in the furnace space B(x, y, z),

In step 1300 it is illustrated that the camera view is subject to a camera view variation ΔCAM_V in the course of time, in particular due to ambient conditions of the furnace, such that the camera view variation causes a deviation ΔPOS of the image point from the object-image position. As respective deviation ΔPOS of the image point from the object-image position is also illustrated with FIG. 4C and FIG. 5B. In particular therein with varying camera pose CAM_P in the course of time the image point (i, j) deviates ΔPOS from the corresponding object-image position. More particular a camera sensor CAM_S pixel PIX is assigned to differing object-image positions A₀, A₁ in the course of time tᵢ such that the camera view variation ΔCAM_V causes a deviation ΔPOS of the image point from the object-image position.

For addressing this problem, the method provides an image treatment process 1400 with steps 1410, 1420, 1430, 1440 as shown below.

In step 1410 a reference image IMG_ref , A_{reference}(i, j) of the furnace space B(x, y, z) is provided at an initial time to during the course of time tᵢ. More particular the reference image (A_{reference}(i, j)) of the furnace space B(x, y, z) is provided at the initial time, and a characteristic object in the furnace space B₀=B(x₀, y₀, z₀) is selected at the initial time, wherein the characteristic object-image position corresponds to an original image point (i₀, j₀) in the reference image A_{reference}(i, j) (FIG. 4A). This is, the original alignment between B₀=B(x₀, y₀, z₀) and A₀=A(i₀, j₀) at time to is given for the reference image IMG_ref; this alignment is denoted by: A₀→A₀[B₀, t₀]

In step 1420 an actual image IMG_act, A(iₙ, jₙ) is provided at a further time t₁ (FIG. 4B) during the course of time tᵢ. More particular the actual image (A(iₙ, jₙ)) is provided at the further time (FIG. 4B).

Characteristic object-image position A₀ originally corresponding to characteristic object B₀ in the reference image (IMG_ref), denoted as A₀→[B₀, t₀], is corresponding to another object B₁ in the actual image (IMG_act), denoted as A₀→A₁[B₁, t₁] New object-image position A₁ corresponding to characteristic object B₀ is determined in the actual image (IMG_act), denoted as A₁→A₁[B₀, t₁].

In step 1430
a deviation ΔPOS is identified for the characteristic object-image position A₁ in the actual image as compared to the characteristic object-image position A₀ in the reference image. Thereby it is recognized that a characteristic object-image position corresponds to an original image point (i₀, j₀) in the reference image A(i₀, j₀) (FIG. 4A) in that an image point (i, j) of the pixel image A(i, j) corresponds to the characteristic object-image position.

In operation more particularly in an automated image analysis
an object-image position is assigned to a characteristic, in particular fixed, object corresponding to one or more selected points of a group or cluster of points of interest, in particular in the reference image A_{reference}(i, j), (FIG. 5A), in particular wherein at least one point of interest in the reference image A_{reference}(i, j) is selected, (FIG. 5A) such that the point of interest is assigned to the characteristic object and the object-image position of the point of interest is determined as an image point (i, j) of the pixel image A_{reference}(i, j). This implies determining the transformation function Tn as explained in the chapter “Determination of the transformation function”.

In step 1440
a deviation-compensation COMP−ΔPOS is provided to the object-image position in the actual image A(iₙ, jₙ), (FIG. 4C) to apply for the varying camera view, wherein the deviation-compensation is based on the deviation identified. More particular, the deviation-compensation is provided to the object-image position in the actual image A(iₙ, jₙ), (FIG. 4C) and applies for the varying camera pose, in that
the deviation-compensation is determined by means of identifying the deviation (A(i₀, j₀)−A(i₁, j₁)) between the original image point (i₀, j₀) in the actual image and the another image point (i₁, j₁) in the actual image (FIG. 4C).

Thus, the camera view variation in the course of time is related to a drift of camera pose. And the camera view variation results in that the image point (i, j) assigned to a sensor pixel of the camera sensor deviates from a corresponding object-image position and results into a difference between an image point read out at the initial time and an image point read out at the further time, and/or
the deviation-compensation to the object-image position in the actual image provides deviation-compensated actual image wherein the sensor pixel of the camera sensor is again related to the corresponding object-image position such that the difference is compensated. This implies using the transformation function Tn as explained above.

Further, in the method 1000

In step 1500 a process parameter is determined by means of the deviation-compensated object-image position in the actual image. More particular as an option the image of the furnace space which is used for relating into the imaging technical map MAP of improved process parameters P* is determined by means of the deviation-compensated object-image position in the actual image.

In step 1600 it is depicted for the method 1000 to use the improved process parameters P* in a control unit CU* as shown in FIG. 10A, FIG. 10B.

1. A method of monitor and/or control of operation of an industrial furnace for processing a heated material, in particular for processing a melt in a melting end of a kiln or the like industrial furnace, wherein the industrial furnace has an inner furnace space comprising a furnace crown, a furnace superstructure and a furnace material basin, wherein in the method:
an image process of at least a part of the furnace space is provided, namely provided with a series of images in the course of time,
wherein an image of the series is provided by means of a camera sensor of a camera, the camera being installed at the furnace with a camera view to the furnace space,
and the image of the furnace space is related to a technical map of at least one process parameter of the furnace space during operation of the furnace by means of an image point read out, and
wherein a process parameter is used in the monitor and/or control of operation, and
an image point of the image, in particular pixel image, corresponds to an object-image position assigned to an object location of an object in the furnace space, wherein the image point is related with a sensor point of the camera sensor,
wherein:
a reference image of the furnace space is provided at an initial time during the course of time,
an actual image is provided at a further time during the course of time,
a characteristic object-image position is identified in the actual image and a corresponding characteristic object-image position is identified in the reference image,
a deviation is identified for the characteristic object-image position in the actual image as compared to the characteristic object-image position in the reference image,
a deviation-compensation is provided to the object-image position in the actual image, in particular to apply for a varying camera view, wherein the deviation-compensation is based on the deviation identified, and
a process parameter is determined by means of the deviation-compensated object image position in the actual image.

2. The method as claimed in claim 1, wherein a deviation-compensation is provided to the actual image wherein the deviation-compensation is based on the deviation identified, and
the image of the furnace space which is used for relating into the technical map of process parameters, wherein the process parameters are determined by means of a deviation-compensated actual image.

3. The method as claimed in claim 1, wherein the camera view is subject to a camera view variation in the course of time, in particular due to ambient conditions of the furnace, such that the camera view variation causes a deviation of the image point from the object-image position.

4. The method as claimed in claim 1, wherein
the camera having a camera position and/or being directed to the furnace space with a camera orientation, wherein a camera pose is assigned to the position and/or orientation of the camera, and/or
with varying camera pose in the course of time the image point deviates from the corresponding object-image position.

5. The method as claimed in claim 1, characterized in that the image is provided with a number of image points, in particular as a pixel image, wherein an image point is assigned to a sensor point, in particular sensor pixel, of the camera sensor.

6. The method as claimed in claim 1, wherein
the reference image of the furnace space is provided at the initial time, and a characteristic object in the furnace space is selected at the initial time, wherein
the characteristic object-image position of the object corresponds to an original image point in the reference image, and
the actual image is provided at the further time, wherein the original image point, being related with the sensor point of the camera sensor in the actual image, corresponds to another object-image position of another object, and/or
the characteristic object-image position of the object is identified to correspond to another image point being related with the sensor point of the camera sensor in the actual image.

7. The method as claimed in claim 6, wherein:
the deviation-compensation is provided to the object-image position in the actual image and applies for the varying camera pose, in that
the deviation-compensation is determined by means of identifying the deviation between the original image point in the actual image and the another image point in the actual image.

8. The method as claimed in claim 1, wherein
a characteristic object-image position corresponds to an original image point in the reference image in that an image point of the image, in particular pixel image, corresponds to the characteristic object-image position and/or
an object-image position is assigned to a characteristic object, in particular fixed object, wherein the characteristic object corresponds to one or more selected points of a group or cluster of points of interest, in particular in the reference image, and/or
at least one point of interest in the reference image is selected, such that the point of interest is assigned to the characteristic object and the object-image position of the point of interest is determined as an image point of the image, in particular pixel image.

9. The method as claimed in claim 8, wherein:
a characteristic object-image position is identified to correspond to another image point in the actual image as compared to the reference image, wherein at least some of the points of interest are identified in the actual image.

10. The method as claimed in claim 6, wherein:
the deviation between the original image point and the another image point in the actual image corresponds to a deviation-relation between at least some of selected points of interest, and the deviation is used to determine the deviation-compensation to the object-image position in the actual image.

11. The method as claimed in claim 1, wherein:
the camera view variation in the course of time is related to a drift of camera pose, and/or
the camera view variation results in that the image point assigned to a sensor pixel of the camera sensor deviates from a corresponding object-image position and results into a difference between an image point read out at the initial time and an image point read out at the further time, and/or
the deviation-compensation to the object-image position in the actual image provides deviation-compensated object-image position in the actual image,
in particular wherein the sensor pixel of the camera sensor is again related to the corresponding object-image position such that the difference is compensated.

12. The method as claimed in claim 10, wherein:
the object-image position is assigned to an object location by an assignment which is evaluated by means of a transformation function, and/or
a deviation-compensating transformation function is applied to the object-image position in the actual image.

13. The method as claimed in claim 12, wherein:
the deviation-relation between said at least some of the selected points of interest, namely as identified in the reference image and in the actual image, is used to determine the deviation-compensating transformation function to the object-image position in the actual image.

14. The method as claimed in claim 11, wherein:
a deviation-compensation to object-image position in the actual image is applied, such that the image point of the image of the deviation-compensated transformed object-image position in the actual image is assigned to the original location of the object, in particular wherein
the assignment is evaluated by means of an inverse transformation function.

15. The method as claimed in claim 1, wherein:
points of interest are identified in the reference image by means of an image analysis, in particular a graphical image analysis, wherein:
processed material, in particular melt, and/or an interface between melt and furnace structure is identified enabling discriminating between the furnace crown and a superstructure and a material basin, and/or
processed material is excluded from selecting the points of interest.

16. The method as claimed in claim 1, wherein:
means of image analysis for discriminating between furnace crown and furnace material basin and selection of points of interest are selected from the group of means comprising:
image analysis means for identifying high values or extrema of pixel amplitude and/or pixel-to-pixel gradient
image analysis means for identifying confined or line or sharp image structures, in particular edge or point like structures
image analysis means for identifying fixed objects as stand-still or essentially static,
neural network image analysis means for learning of discriminating between furnace crown and superstructure, furnace material basin and other objects.

17. A control system adapted to execute the method as claimed in claim 1, wherein
a camera is adapted in that
an image process of at least a part of the furnace space is provided, namely provided with a series of images in the course of time,
wherein an image of the series is provided by means of a camera sensor of a camera, the camera being installed at the furnace with a camera view to the furnace space, and a read out module is adapted in that
the image of the furnace space is related to a technical map of at least one process parameter of the furnace space during operation of the furnace by means of an image point read out, and
wherein a process parameter is used in the monitor and/or control of operation, and
an image point of the image, in particular pixel image, corresponds to an object-image position assigned to an object location of an object in the furnace space, wherein the image point is related with a sensor point of the camera sensor
characterized in that
an image taking module is adapted in that
a reference image of the furnace space is provided at an initial time during the course of time,
an actual image is provided at a further time during the course of time, and
a deviation-compensation module is adapted in that
a characteristic object-image position is identified in the actual image and a corresponding characteristic object-image position is identified in the reference image,
a deviation is identified for the characteristic object-image position in the actual image as compared to the characteristic object-image position in the reference image,
and a deviation-compensation module is adapted in that
a deviation-compensation is provided to the object-image position in the actual image, in particular to apply for a varying camera view, wherein the deviation-compensation is based on the deviation identified, and
a control unit is adapted in that
a process parameter is determined by means of the deviation-compensated object image position in the actual image.

18. The control system of claim 17, wherein enhanced process parameters are based on corrected camera imaging results and the enhanced process parameters are used to monitor the industrial furnace operation and/or to control the industrial furnace operation in a feed-forward loop or a feed-back control loop of control.

19. The control system as claimed in claim 17, wherein images obstructed by the deposits and/or blurred images and/or barrel and pincushion distortion or the like optical system distortions are compensated.
